(19) United States
(12) Patent Application Publication
(10) Pub. No.: US 2026/0122599 A1
(43) Pub. Date: Apr. 30, 2026

(54) Unified Radio Resource Management for Data Exchange and Ranging Operations

(71) Applicant: Cisco Technology, Inc., San Jose, CA (US)

(72) Inventors: Jerome Henry, Pittsboro, NC (US); Laurent Alexandre Pierrugues, San Jose, CA (US); Vishal S. Desai, San Jose, CA (US)

(21) Appl. No.: 18/933,937

(22) Filed: Oct. 31, 2024

(51) Int. Cl. H04W 64/00; H04B 17/318; H04W 8/22; H04W 24/02

(52) U.S. Cl. CPC H04W 64/00; H04B 17/318; H04W 8/22; H04W 24/02

(57) ABSTRACT

Devices, networks, systems, methods, and processes for dynamically allocating channel widths to Access Point (AP) radios for both a data exchange operation and a ranging operation are provided herein. A wireless network may include a Wireless Local Area Network Controller (WLC) and a set of APs. A network device of the wireless network may allocate a first channel width to a plurality of radios of the set of APs for the data exchange operation. Further, the network device may determine that the set of APs is enabled for the ranging operation. Furthermore, the network device may allocate a second channel width to a set of radios of the plurality of radios for the ranging operation such that inefficiencies in channel width allocation for one or both the data exchange operation and the ranging operation are suppressed. The allocated second channel width may be different from the allocated first channel width.

The present disclosure relates to wireless networks. More particularly, the present disclosure relates to dynamically allocating channel widths to access point radios for both data exchange and ranging operations by incorporating radio frequency-related requirements of the data exchange and ranging operations.

### BACKGROUND

Wi-Fi, or wireless fidelity, has become a fundamental technology in today's world, enabling wireless connectivity across a broad spectrum of devices. The significance of Wi-Fi stems from the convenience and flexibility it offers, allowing for seamless Internet access and facilitating communication, data transfer, and various online activities. As a cornerstone of connectivity in homes, businesses, public spaces, and educational institutions, Wi-Fi assists in enhancing productivity and connectivity for individuals and organizations alike.

As technology has advanced, the role of Wi-Fi has also evolved to meet growing demands for faster speeds, greater bandwidth, and improved security. These increasing demands have driven the continuous development of more advanced Wi-Fi standards, which are regularly updated to deliver enhanced performance, greater capacity, and improved efficiency. One such advancement is the introduction of Multi-Link Operation (MLO), allowing stations to operate with multiple active radios. MLO may enable stations to connect to a single Access Point (AP) while utilizing multiple links for improved throughput and redundancy. Additionally, MLO may allow stations to connect to multiple APs simultaneously, offering even greater flexibility and performance.

These advanced functionalities allow stations to run two or more applications in parallel, each requiring different radio resources. For instance, at any given time, a station can assign one radio for a data exchange operation while using another radio for a separate task, such as ranging or sensing. Current Radio Resource Management (RRM) techniques assist in selecting radios for the data exchange operation by incorporating Radio Frequency (RF)-related requirements, such as throughput, signal strength, and interference management. However, these RRM techniques primarily focus on data exchange operations and do not adequately consider the RF requirements of other concurrent applications, such as ranging or sensing tasks. Consequently, the effectiveness of these functionalities may be limited when the RF-related requirements of different applications are not aligned.

In practice, the RF-related requirements of different applications often conflict. For example, if a station is concurrently running a data exchange operation and a ranging operation, each operation may demand distinct RF-related requirements. This disparity in the RF-related requirements may present a significant challenge for RRM, particularly in efficiently allocating channel widths and other radio resources. Inefficient allocation of channel width and/or radio resources may result in suboptimal performance for one or both operations, leading to reduced data throughput or inaccurate ranging results.

### SUMMARY OF THE DISCLOSURE

Systems and methods for dynamically allocating channel widths to access point radios for both data exchange and ranging operations by incorporating radio frequency-related requirements of the data exchange and ranging operations in accordance with embodiments of the disclosure are described herein. In one aspect of the present disclosure, a network device is provided. The network device may comprise a network controller configured to provide access to a network including a set of Access Points (APs), where the set of APs is associated with a plurality of radios. The network device may further comprise a processor and a memory communicatively coupled to the processor. The memory may comprise a Radio Resource Management (RRM) logic configured to allocate a first channel width to the plurality of radios for one or more data exchange operations. The RRM logic may be further configured to determine that the set of APs is enabled for a ranging operation and allocate a second channel width to a set of radios of the plurality of radios for the ranging operation, where the second channel width is different from the first channel width.

In many embodiments, to allocate the second channel width to the set of radios, the RRM logic may be further configured to obtain radio data associated with the plurality of radios and assign a weight to each radio of the plurality of radios based on the radio data. Further, RRM logic may be configured to compare the assigned weight of each radio of the plurality of radios with a weight threshold and select, from the plurality of radios, the set of radios based on the comparison. The second channel width may be allocated to the selected set of radios. In a number of embodiments, the radio data comprises at least one of: a Radio Frequency (RF) band, bandwidth usage information of the one or more data exchange operations, or a Received Signal Strength Indicator (RSSI), associated with at least one radio of the plurality of radios.

In a variety of embodiments, the RRM logic may be further configured to receive one or more ranging feedback messages associated with the ranging operation. Further, the RRM logic may be configured to modify the second channel width based on the one or more ranging feedback messages. In more embodiments, the modification of the second channel width may comprise one of increasing the second channel width or decreasing the second channel width.

In additional embodiments, the RRM logic may be further configured to receive a ranging feedback message associated with a radio of the set of radios. The ranging feedback message may indicate a ranging accuracy associated with the ranging operation. Further, the RRM logic may be configured to compare the ranging accuracy with a ranging accuracy threshold and reduce the weight of the radio in response to the ranging accuracy being lower than the ranging accuracy threshold.

In further embodiments, the RRM logic may be further configured to determine that the reduced weight of the radio is lower than the weight threshold. Further, the RRM logic may be configured to remove the radio from the set of radios in response to determining that the reduced weight of the radio is lower than the weight threshold. In still more embodiments, the ranging feedback message may comprise a Location Measurement Report (LMR).

In still further embodiments, to allocate the second channel width to the set of radios, the RRM logic may be further configured to acquire historical ranging data associated with the set of APs. Further, the RRM logic may be configured to determine a ranging cadence of each AP of the set of APs based on the historical ranging data. Furthermore, the RRM logic may be configured to select the set of radios from the plurality of radios based on the determined ranging cadence.

In still additional embodiments, to select the set of radios from the plurality of radios, the RRM logic may be further configured to compare the determined ranging cadence with a ranging cadence threshold and identify at least one geographical zone including one or more APs of the set of APs with the determined ranging cadence being greater than the ranging cadence threshold, where the selected set of radios is associated with the one or more APs. In some more embodiments, the RRM logic may be further configured to control one or more radios, of the plurality of radios that are excluded from the set of radios, to prohibit transmission of a ranging capability announcement. In yet more embodiments, the RRM logic may be further configured to utilize a Machine Learning (ML) model to allocate the second channel width to the set of radios.

In another aspect of the present disclosure, a network device is provided. The network device may include a set of radios, a processor, and a memory communicatively coupled to the processor. The memory may comprise an RRM logic that is configured to operate a first subset of radios of the set of radios at a first channel width for one or more data exchange operations. Further, the RRM logic may be configured to receive a ranging request for a ranging operation and operate a second subset of radios of the set of radios at a second channel width for the ranging operation. The allocated second channel width may be different from the allocated first channel width.

In still yet more embodiments, the RRM logic may be further configured to receive an association request from a client device. Further, the RRM logic may be configured to transmit, to the client device, an indication that the first subset of radios is configured for the one or more data exchange operations in response to receiving the association request. In many further embodiments, the indication may comprise at least one of a Basic Service Set Identifier (BSSID) of the network device or channel information associated with the first subset of radios.

In many additional embodiments, the ranging request may be received from a client device, and the RRM logic may be further configured to transmit, to the client device, an indication that the second subset of radios is configured for the ranging operation. In still yet further embodiments, the indication may comprise at least one of a Basic Service Set Identifier (BSSID) of the network device or channel information associated with the second subset of radios. In still yet additional embodiments, the RRM logic may be further configured to prohibit transmission of an announcement indicating availability of the second subset of radios for the one or more data exchange operations in response to operating the second subset of radios at the second channel width.

In yet another aspect of the present disclosure, a method is provided. The method may comprise acquiring first channel requirement information associated with a data exchange operation and second channel requirement information associated with a ranging operation. Further, the method may comprise receiving ranging data associated with a set of APs for a plurality of historical ranging events and training a ML model based on the first channel requirement information, the second channel requirement information, and the ranging data. The trained ML model may be configured to reserve one or more radios of the set of APs to utilize a target channel width for the ranging operation. The target channel width may be different from a channel width associated with the data exchange operation. In several embodiments, the ranging data for a historical ranging event of the plurality of historical ranging events may comprise at least one of: a client device identifier, a channel number, a channel width, a mode of ranging, a count of frames exchanged in the historical ranging event, or an outcome of the historical ranging event.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual network diagram of various environments in which a Radio Resource Management (RRM) logic can operate on a plurality of network devices in accordance with various embodiments of the disclosure;

FIG. 2 is a conceptual block diagram of an indoor environment for channel width allocation in accordance with various embodiments of the disclosure.

FIG. 3 is a diagram depicting various subsets of artificial intelligence in accordance with various embodiments of the disclosure.

FIG. 4 illustrates different methods of machine-based learning in accordance with various embodiments of the disclosure;

FIG. 5 is a machine learning lifecycle in accordance with various embodiments of the disclosure;

FIG. 6 is an exemplary neural network in accordance with various embodiments of the disclosure;

FIG. 7 is a flowchart depicting a process for controlling a set of Access Points (APs) to operate at a first channel width and/or a second channel width in accordance with various embodiments of the disclosure;

FIG. 8 is a flowchart depicting a process for modifying a channel width in accordance with various embodiments of the disclosure;

FIG. 9 is a flowchart depicting a process for removing a radio from a set of radios in accordance with various embodiments of the disclosure;

FIG. 10 is a flowchart depicting a process for allocating at least one of the first channel width or the second channel width to the set of APs in accordance with various embodiments of the disclosure;

FIG. 11 is a flowchart depicting a process for transmitting at least one of a data exchange indication or a ranging indication in accordance with various embodiments of the disclosure;

FIG. 12 is a flowchart depicting a process for training an ML model in accordance with various embodiments of the disclosure; and

FIG. 13 is a conceptual block diagram of a device suitable for configuration with the RRM logic in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein for dynamically allocating channel widths to Access Point (AP) radios in a wireless network for a data exchange operation and/or a ranging operation. The ranging operation may involve an exchange of Fine Timing Measurement (FTM) frames between a station (STA) and an AP to accurately measure the distance between them. The ranging operation may include calculation of round-trip time of signals to determine the physical range, enabling precise location tracking within the wireless network. The wireless network may include a set of APs and/or a WLC. Each AP of the set of APs may correspond to a network device that allows at least one client device to connect to the Internet or other client devices. In various examples, the set of APs may include a plurality of radios. For example, each radio of the plurality of radios may include a communication interface that is configured to transmit (and/or receive) one or more Radio Frequency (RF) signals to facilitate a wireless connection with the client device. As used herein, the client device may correspond to a mobile computing device that includes a smartphone, a tablet, a laptop/notebook, a wearable device, or the like. As used herein, the WLC may correspond to a network device that manages the set of APs to ensure efficient data routing, security, and configuration.

As wireless technology advances, the demand for faster and more efficient networks is rapidly growing. To meet these evolving requirements, Multi-Link Operation (MLO) has been introduced. MLO allows the client device to simultaneously connect to one or more APs by utilizing multiple links associated with the client device. This advanced functionality may enable the client device to run multiple operations (e.g., the data exchange operation, the ranging operation, or the like) in parallel, each requiring different radio requirements. Current RRM techniques may assist in selecting channels for the data exchange operation by incorporating channel requirements, such as throughput, signal strength, and interference management. However, these RRM techniques may not incorporate channel requirements of the ranging operation. As a result, the current RRM techniques may select only narrower channels that would avoid interference. However, the ranging operation may be optimal if the ranging operation is executed with wider channels. To this end, the present disclosure provides the network device (e.g., the WLC or an AP of the set of APs) that facilitates channel width allocation for the data exchange operation and/or the ranging operation.

In a variety of embodiments, the network device may be configured to determine whether the set of APs is enabled for the ranging operation. In various examples, the set of APs may be provided with a ranging operation feature associated with ranging operation. In an example, the ranging operation feature may have two states (e.g., an on-state and an off-state). For example, if the ranging operation feature is in the on-state on the set of APs, the network device may determine that the set of APs is enabled for the ranging operation. Conversely, if the ranging operation feature is in the off-state on the set of APs, the network device may determine that the set of APs is not enabled for the ranging operation. Additionally, if the ranging operation feature is in the on-state on at least one AP of the set of APs, the network device may determine that the at least one AP is enabled for the ranging operation.

In numerous embodiments, upon determining that the set of APs is not enabled for the ranging operation, the network device may receive first channel requirement information associated with the data exchange operation from the set of APs. For example, the first channel requirement information may include an indication of specific data throughput to be achieved for the data exchange operation, an indication of interference to be avoidance for the data exchange operation, or the like. In an example, the interference may include an Overlapping Basic Service Set (OBSS) interference associated with the set of APs. Further, the network device may be configured to allocate at least one first channel width to the plurality of radios for the data exchange operation based on the received first channel requirement information. In various examples, the network device may allocate the first channel width to the plurality of radios such that the interference indicated in the first channel requirement information is minimized without compromising the specific data throughput. As used herein, the first channel width may represent a frequency range that a channel can occupy for executing the data exchange operation.

In numerous additional embodiments, upon determining that the set of APs is enabled for the ranging operation, the network device may be configured to acquire historical ranging data associated with the set of APs. In various examples, the historical ranging data may be associated with a plurality of historical ranging events performed between the set of APs and one or more client devices. In an example, the historical ranging data may include ranging data of each historical ranging event of the plurality of historical ranging events. For example, the ranging data of a historical ranging event of the plurality of historical ranging events may include at least one of: a client identifier, a channel number, a channel width, a mode of ranging, a count of frames, or an outcome of the historical ranging event. The client identifier may indicate a Media Access Control (MAC) address of a client device of the client devices with which the historical ranging event was performed. The channel number may represent a specific channel (e.g., a channel-38, a channel-46, or the like) that was utilized to perform the historical ranging event. The channel width may represent a specific frequency range (e.g., 40 MHz, 80 MHz, or the like) that was utilized to perform the historical ranging event. The mode of ranging may represent one or more Wi-Fi protocols (e.g., IEEE 802.11mc, IEEE 802.11az, or the like) that were utilized to perform the historical ranging event. The count of frames may represent a number of frames exchanged in the historical ranging event. The outcome of the historical ranging event may indicate either a success of the historical ranging event or a failure of the historical ranging event.

In further embodiments, upon acquiring the historical ranging data, the network device may determine a ranging cadence of each AP of the set of APs. In an example, the ranging cadence of an AP of the set of APs may indicate a count of ranging operation executed by the AP. Upon determining the ranging cadence of each AP of the set of APs, the network device may identify at least one geographical zone that includes one or more APs whose ranging cadences are greater than a ranging cadence threshold. Upon identifying the geographical zone, the network device may determine, from the plurality of radios, a group of radios that are associated with the one or more APs.

In still further embodiments, upon determining the group of radios, the network device may obtain radio data associated with the group of radios. For example, the radio data may include at least one of: an RF band associated with each radio of the group of radios, bandwidth usage information of the data exchange operation associated with each radio of the group of radios, or a Received Signal Strength Indicator (RSSI) associated with each radio of the group of radios. In an example, the RF band of a specific radio of the group of radios may indicate a specific frequency band (e.g., a 2.4 GHz band, a 5 GHz band, a 6 GHz band, or the like) supported by the specific radio. The bandwidth usage information of the specific radio may indicate a data traffic amount exchanged between the specific radio and the client device while performing the data exchange operation. The RRSI associated with the specific radio may indicate a signal power (or signal strength) of a wireless signal of the client device measured by the specific radio.

In still yet further embodiments, upon obtaining the radio data, the network device may acquire second channel information associated with the ranging operation. For example, the second channel requirement information may include at least one of: an indication of a specific channel width beyond which the ranging operation is optimal or an indication of a specific RSSI range within which the ranging operation is optimal. Upon acquiring the second channel information, the network device may assign a weight to each radio of the group of radios based on the obtained radio data and/or the second channel information. For example, the network device may assign, among the group of radios, higher weights to one or more radios whose RF bands can support the specific channel width, whose data traffic amounts are lower than a data traffic threshold, and/or whose RSSIs are within the specific RSSI range.

In more embodiments, upon assigning the weight to each radio of the group of radios, the network device may select a set of radios from the group of radios. In order to select the set of radios, the network device may compare the assigned weight of each radio of the group of radios to determine whether the assigned weight of each radio of the group of radios is greater than a weight threshold. Further, the network device may select the set of radios from the group of radios based on the comparison. In an example, the network device may select, from the group of radios, the set of radios whose assigned weights are greater than the weight threshold.

In still more embodiments, upon selecting the set of radios, the network device may allocate at least one second channel width to the set of radios based on the specific channel width included in the second channel requirement information and/or the channel widths included in the historical ranging data. In various examples, the network device may allocate the second channel width such that the second channel width is equal to or greater than the specific channel width. In numerous examples, the second channel width may be different from the first channel width since the data exchange operation requires a narrower channel width that minimizes the interference and the ranging operation requires a wider channel width that enables the ranging operation to be executed optimally.

In yet more embodiments, upon allocating the second channel width, the network device may control the identified APs of the geographical zone to operate the set of radios at the second channel width for executing the ranging operation with the client device. In an example, the network device may select a set of channels corresponding to the second channel width, and control the identified APs to operate the set of radios on the selected channels. In still yet more embodiments, the network device may determine, from the plurality of radios, a set of remaining radios that are not included in the set of radios. Further, the network device may control the set of APs to operate the set of remaining radios at the first channel width for executing the data exchange operation with the client device.

In many embodiments, upon executing the data exchange operation and/or the ranging operation, the network device may receive one or more feedback messages from the client device. For example, the feedback messages may include a data exchange feedback message associated with the data exchange operation and/or a ranging feedback message associated with the ranging operation. The ranging feedback message may include the measurement of the distance between the client device and an AP of the identified APs, a ranging accuracy of the measurement, or the like. In an example, the ranging feedback message may correspond to a Location Measurement Report (LMR). The data exchange feedback message may include an accuracy of the data exchange operation indicating whether the data exchange operation was executed with the required data throughput or the like.

In many further embodiments, the network device may receive the ranging feedback message associated with each radio of the set of radios. Upon receiving the ranging feedback message associated with each radio of the set of radios, the network device may determine whether the ranging accuracy for each radio of the set of radios is lower than a ranging accuracy threshold. For example, if the ranging accuracy for each radio of the set of radios is lower than the ranging accuracy threshold, the network device may modify the second channel width. The modification of the second channel width may include one of increasing or decreasing the second channel width by a specific channel width value. Conversely, if the ranging accuracy for each radio of the set of radios is not lower than the ranging accuracy threshold, the network device may determine whether the set of radios includes at least one radio whose ranging accuracy is lower than the ranging accuracy threshold. If the set of radios does not include the radio whose accuracy is lower than the ranging accuracy threshold, the network device may prohibit the modification of the second channel width.

In many additional embodiments, if the ranging accuracy of the radio of the set of radios is lower than the ranging accuracy threshold, the network device may reduce the assigned weight of the radio. Further, the network device may determine whether the reduced weight of the radio is lower than the weight threshold. For example, if the reduced weight of the radio is lower than the weight threshold, the network device may remove the radio from the set of radios in anticipation that the radio is not suitable for the ranging operation. Conversely, if the reduced weight of the radio is not lower than the weight threshold, the network device may retain the radio in the set of radios.

In additional embodiments, the network device may control the set of APs to at least one of: transmit a ranging capability announcement or prohibit the transmission of the ranging capability announcement. Specifically, the network device may control the selected set of radios to transmit the ranging capability announcement and the determined set of remaining radios to prohibit the transmission of the ranging capability announcement. For example, the ranging capability announcement transmitted by a radio of the selected set of radios may include an indication that the radio is configured for the ranging operation. The indication may include a Basic Service Set Identifier (BSSID) of an AP that is associated with the radio, an identifier of the radio, and/or channel information associated with the radio.

In still additional embodiments, the network device may control the set of APs to at least one of: transmit a data exchange capability announcement or prohibit the transmission of the data exchange capability announcement. Specifically, the network device may control the determined set of remaining radios to transmit the data exchange capability announcement and the selected set of radios to prohibit the transmission of the data exchange capability announcement. For example, the data exchange capability announcement transmitted by a radio of the determined set of remaining radios may include an indication that the radio is configured for the data exchange operation.

In several embodiments, the network device may utilize a Machine learning (ML) model to allocate the first channel width and the second channel width to the determined set of remaining radios and the selected set of radios, respectively. For example, the ML model may include a reinforcement learning model, a neural network (NN), a deep neural network (DNN), a generative model, or the like. In an example, the ML model may be pre-trained using one or more training data sets to allocate the first channel width and the second channel width. For instance, the training data sets may include the historical ranging data associated with the set of APs, the first channel requirement information, the second channel requirement information, or the like.

Advantageously, allocating the first channel width to the set of APs may trigger the set of APs to operate the plurality of radios at the first channel width for the data exchange operation. Further, determining that the set of APs is enabled for the ranging operation may trigger the network device to allocate the second channel width to the set of radios of the plurality of radios for the ranging operation. Further, the allocation of the second channel width to the set of radios may trigger the set of APs to operate the set of radios at the second channel width for the ranging operation. The allocation of the first channel width and the second channel width for the data exchange operation and the ranging operation may enable the network device to suppress inefficiencies in channel width allocation that could lead to suboptimal performance in one or both the data exchange and ranging operations.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

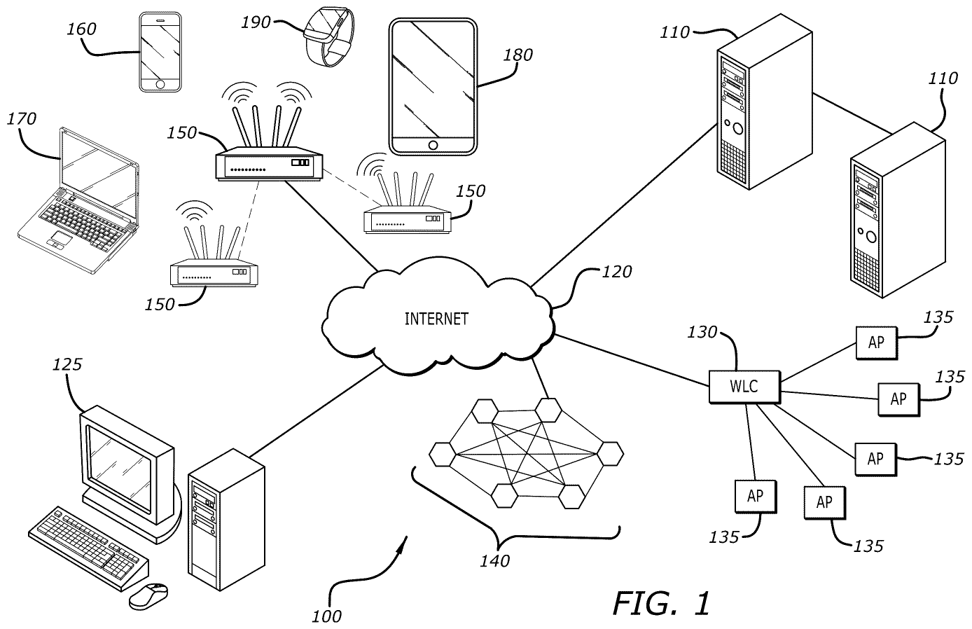

Referring to FIG. 1, a conceptual network diagram 100 of various environments in which a Radio Resource Management (RRM) logic can operate on a plurality of network devices in accordance with various embodiments of the disclosure is shown. Those skilled in the art will recognize that the RRM logic may include various hardware and/or software deployments and may be configured in a variety of ways. In many embodiments, the RRM logic may be configured as a standalone device, exist as a logic in another network device, be distributed among various network devices operating in tandem, or be remotely operated as part of a cloud-based network management tool. In further embodiments, one or more servers 110 may be configured with the RRM logic or may otherwise operate as the RRM logic. In many further embodiments, the RRM logic may operate on the one or more servers 110 connected to a communication network 120 (e.g., the “Internet”). The communication network 120 may include wired networks or wireless networks. The RRM logic may be provided as a cloud-based service that may service remote networks, such as, but not limited to a deployed network 140.

However, in additional embodiments, the RRM logic may be operated as a distributed logic across multiple network devices. In the embodiments depicted in FIG. 1, a plurality of Access Points (APs) 150 may operate as the RRM logic in a distributed manner or may have one specific device operate as the RRM logic for all of the neighboring or sibling APs 150. The APs 150 may facilitate Wi-Fi connections for various electronic devices, such as but not limited to, client devices 160-190 including at least one laptop computer 170, at least one cellular phone 160, at least one portable tablet computer 180, and at least one wearable computing device 190.

In numerous embodiments, the RRM logic may be integrated within another network device. In an example, a wireless LAN controller (WLC) 130 may be configured with the RRM logic or may otherwise operate as the RRM logic. The WLC 130 may control operations associated with a set of APs 135 that are connected, either wired or wirelessly, to the WLC 130. In more embodiments, a personal computer 125 may be utilized to access and/or manage various aspects of the RRM logic, either remotely or within the network itself. In the embodiments depicted in FIG. 1, the personal computer 125 communicates over the communication network 120 and may access the RRM logic of the servers 110, the APs 150, or the WLC 130.

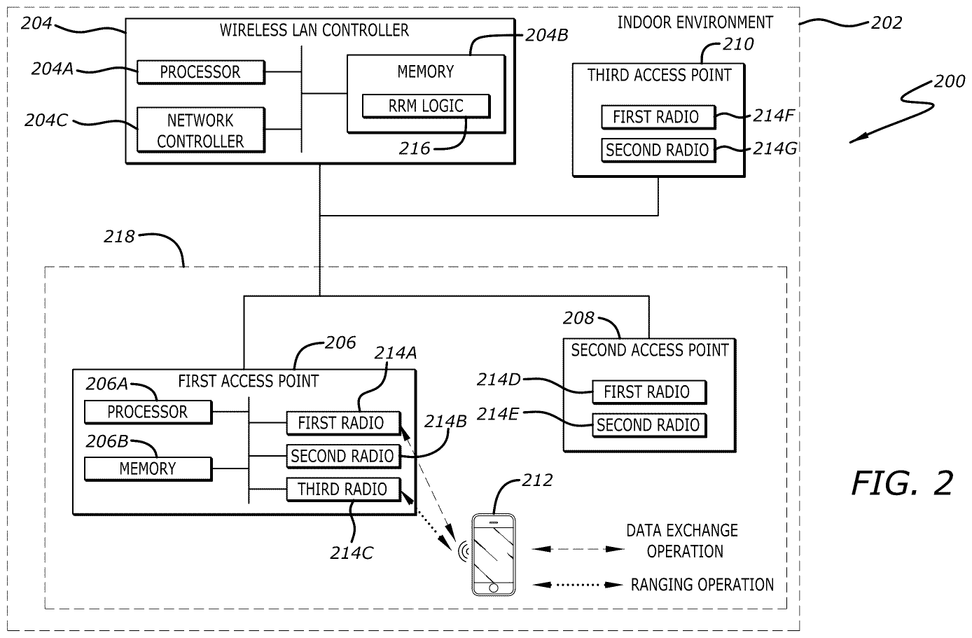

Although a specific embodiment for various environments that the RRM logic may operate on a plurality of network devices suitable for carrying out the various steps, processes, methods, and operations described herein is discussed with respect to FIG. 1, any of a variety of systems and/or processes may be utilized in accordance with embodiments of the disclosure. In many non-limiting examples, the RRM logic may be provided as a device or software separate from the WLC 130 or the RRM logic may be integrated into the WLC 130. The elements depicted in FIG. 1 may also be interchangeable with other elements of FIGS. 2-13 as required to realize a particularly desired embodiment.

Referring to FIG. 2, a conceptual block diagram 200 of an indoor environment 202 for channel width allocation in accordance with various embodiments of the disclosure is shown. In the embodiments shown in FIG. 2, the indoor environment 202 may include a WLC 204, a set of APs 206-210, and a client device 212. The set of APs 206-210 may include a first AP 206, a second AP 208, and a third AP 210. Each AP of the set of APs 206-210 may be connected to the WLC 204 either via a wired connection or a wireless connection. As used herein, the WLC 204 may include a network device that manages multiple APs (e.g., the set of APs 206-210) in order to ensure efficient data routing, security, and configuration. As used herein, an AP (e.g., the first AP 206, the second AP 208, or the third AP 210) may include a network device that allows one or more client devices (e.g., the client device 212) to connect to a network (e.g., the Internet) or other client devices. As used herein, the client device 212 may include a mobile computing device such as a smartphone, a tablet, a laptop/notebook, a wearable device, or the like.

In the embodiments shown in FIG. 2, the WLC 204 may include a processor 204A, a memory 204B communicatively coupled to the processor 204A, and a network controller 204C communicatively coupled to at least one of the processor 204A or the memory 204B. The first AP 206 may include a processor 206A and a memory 206B communicatively coupled to the processor 206A. Although it is not shown in FIG. 2, each of the second AP 208 and the third AP 210 may include a processor and a memory, similar to the first AP 206.

In a number of embodiments, the processors 204A and 206A may include suitable logic, circuitry, and interfaces that are configured to execute instructions stored in the memories 204B and 206B, respectively. The processors 204A and 206A may correspond to Application-Specific Integrated Circuit (ASIC) processors, Complex Instruction Set Computing (CISC) processors, Central Processing Units (CPUs), Explicitly Parallel Instruction Computing (EPIC) processors, Very Long Instruction Word (VLIW) processors, or other processors or circuits. The memories 204B and 206B may include suitable logic, circuitry, and interfaces that are configured to store a machine code or the instructions executable by the processors 204A and 206A, respectively. The memories 204B and 206B may correspond to Random Access Memories (RAMs), Read Only Memories (ROMs), Electrically Erasable Programmable Read-Only Memories (EEPROMs), Hard Disk Drives (HDDs), Solid-State Drives (SSDs), or Secure Digital (SD) cards. The network controller 204C may include suitable logic, circuitry, and interfaces that are configured to provide access to a network including the set of APs 206-210. Additionally, in some more examples, the network controller 204C may be embodied in at least one AP of the set of APs 206-210.

In the embodiments shown in FIG. 2, the first AP 206 may further include a set of radios 214A-214C including a first radio 214A, a second radio 214B, and a third radio 214C. The set of radios 214A-214C may be communicatively coupled to at least one of the processor 206A or the memory 206B. Although it is shown that the first AP 206 includes three radios, the scope of the present disclosure is not limited to it. For example, the first AP 206 may include two or more radios without deviating from the scope of the present disclosure. Similar to the first AP 206, each of the second AP 208 and the third AP 210 may include a set of radios 214D and 214E and a set of radios 214F and 214G, respectively. Hereinafter, the set of radios 214A-214C, the set of radios 214D and 214E, and the set of radios 214F and 214G may be collectively referred to as a plurality of radios 214A-214G.

In a variety of embodiments, each radio of the plurality of radios 214A-214G may include a communication interface that is configured to transmit (and/or receive) Radio Frequency (RF) signals to facilitate wireless communication with one or more client devices (e.g., the client device 212). For example, the communication interface may include a transceiver, an antenna, a digital signal processor (DSP), one or more amplifiers, or the like. Each radio of the plurality of radios 214A-214G may be configured to operate on a specific frequency band. For example, the specific frequency band may include one of a 2.4 Gigahertz (GHz) band, a 5 GHz band, a 6 GHz band, or the like. Each radio of the plurality of radios 214A-214G may be provided with a specific identifier (e.g., a Media Access Control (MAC) address) that is utilized to uniquely identify the corresponding radio in the indoor environment 202.

In numerous embodiments, the set of APs 206-210 may be provided with a ranging operation feature. A “ranging operation” may refer to data exchanges of (e.g., exchange of Fine Time Measurement “FTM” frames) between a station “STA” (e.g., the client device 212) and an AP (e.g., the set of APs) to accurately measure the distance between them. The ranging operation may include calculation of round-trip time of signals to determine the physical range, enabling precise location tracking within the wireless network. In an example, the ranging operation may include an FTM operation. For example, the ranging operation feature may have two states (e.g., an on-state and an off-state). In an example, the ranging operation feature may be switched between the on-state and the off-state based on a user selection, a specific configuration indicating a specific time of the day, or the like. For instance, if the ranging operation feature is turned-on on a particular AP of the set of APs, the particular AP may be configured to execute a ranging operation with at least one client device (e.g., the client device 212). Upon executing the ranging operation, the particular AP may exchange one or more RF signals with the at least one client device to assist the at least one client device in determining its distance relative to the particular AP. The ranging operation may be associated with various applications (e.g., a location-tracking application, a navigation application, or the like). Conversely, if the ranging operation feature is turned-off on the particular AP, the particular AP may prohibit the execution of the ranging operation.

In numerous additional embodiments, the set of APs 206-210 may be configured to execute a data exchange operation with one or more client devices (e.g., the client device 212). For example, if the data exchange operation is executed on one or more APs of the set of APs 206-210, the one or more APs may exchange multimedia data related to one or more multimedia applications with the one or more client devices. The multimedia applications may include a gaming application, a video-conferencing application, a calling application, or the like.

In various embodiments, the indoor environment 202 may be provided with an RRM logic 216. In the embodiments shown in FIG. 2, the RRM logic 216 may be embodied in the WLC 204. Specifically, the RRM logic 216 may be embodied in the memory 204B of the WLC 204. Although it is shown that the RRM logic 216 can be embodied in the memory 204B, the scope of the present disclosure should not be limited to it. For example, the RRM logic 216 may be embodied in the processor 204A of the WLC 204 or may be provided as a standalone entity within the WLC 204.

In operation, the RRM logic may be configured to dynamically allocate channel widths to the plurality of radios 214A-214G for executing one or more operations (e.g., the data exchange operation, the ranging operation, or the like) between one or more APs of the set of APs 206-210 and one or more client devices. As used herein, a channel width may refer to a frequency range that a channel can occupy for executing the one or more operations. For example, the channel width may include one of a 20 Megahertz (MHz) channel width, a 40 MHz channel width, a 80 MHz channel width, a 160 MHz channel width, or the like. In order to dynamically allocate the channel widths to the plurality of radios 214A-214G, the WLC 204 may be configured to determine whether the set of APs 206-210 is enabled for the ranging operation. In an example, the WLC 204 may determine whether the set of APs 206-210 is enabled for the ranging operation based on the ranging operation feature associated with the set of APs 206-210. For example, if the ranging operation feature is turned-off on each AP of the set of APs 206-210, the WLC 204 may determine that the set of APs 206-210 is not enabled for the ranging operation. Conversely, if the ranging operation feature is turned-on on each AP of the set of APs 206-210, the WLC 204 may determine that the set of APs 206-210 is enabled for the ranging operation. Additionally, if the ranging operation feature is turned-on on one or more APs of the set of APs 206-210, the WLC 204 may determine that the one or more APs of the set of APs 206-210 is enabled for the ranging operation.

In many embodiments, upon determining that the set of APs 206-210 is not enabled for the ranging operation, the WLC 204 may be configured to receive first channel requirement information (also referred to as first RF-related requirements) associated with the data exchange operation from the set of APs 206-210. For example, the first channel requirement information may include an indication of specific data throughput to be achieved for the data exchange operation, an indication of interference to be avoidance for the data exchange operation, or the like. In an example, the interference may include an Overlapping Basic Service Set (OBSS) interference associated with the set of APs 206-210. Further, the WLC 204 may be configured to allocate at least one first channel width to the plurality of radios 214A-214G for the data exchange operation based on the received first channel requirement information. In an example, the WLC 204 may allocate the first channel width to the plurality of radios 214A-214G in such a way that the OBSS interference is minimized without compromising the specific data throughput. For example, in order to minimize the OBSS interference, the WLC 204 may allocate, as the first channel width, a narrower channel width (e.g., the 20 MHz channel width) among a set of available channel widths that reduces the OBSS interference. Furthermore, the WLC 204 may be configured to control the set of APs 206-210 to operate one or more radios of the plurality of radios 214A-214G at the allocated first channel width. In an example, the WLC 204 may select one or more channels corresponding to the allocated first channel width and control the set of APs 206-210 to operate on the selected channels for executing the data exchange operation with the client device 212.

In many further embodiments, upon determining that the set of APs 206-210 is enabled for the ranging operation, the WLC 204 may be configured to identify at least one geographical zone 218 within the indoor environment 202. In an example, the geographical zone 218 may correspond to a specific geographical area of the indoor environment 202 where a count of the execution of the ranging operation is greater than a count threshold. In order to identify the geographical zone 218, the WLC 204 may be configured to acquire historical ranging data associated with the set of APs 206-210. In an example, the historical ranging data may be acquired from the memory 204B of the WLC 204.

In many additional embodiments, the historical ranging data may be associated with a plurality of historical ranging events performed between the set of APs 206-210 and at least one client device (e.g., the client device 212). “Historical ranging events” may refer to past records of ranging exchanges, including timestamps, RSSI, channel width, and distance estimates, used to optimize future operations and improve accuracy. For instance, upon performing a historical ranging event of the plurality of historical ranging events, one or more APs of the set of APs 206-210 may report ranging data to the WLC 204. The ranging data may include at least one of: a client identifier, a channel number, a channel width, a mode of ranging, a count of frames, or an outcome of the historical ranging event. The client identifier may indicate a MAC address of a client device with which the historical ranging event was performed. The channel number may represent a specific channel (e.g., a channel-38, a channel-46, or the like) that was utilized to perform the historical ranging event. The channel width may represent a specific frequency range (e.g., 40 MHz, 80 MHz, or the like) that was utilized to perform the historical ranging event. The mode of ranging may represent one or more Wi-Fi protocols (e.g., IEEE 802.11mc, IEEE 802.11az, or the like) that were utilized to perform the historical ranging event. The count of frames may represent a number of frames exchanged in the historical ranging event. The outcome of the historical ranging event may indicate either a success of the historical ranging event or a failure of the historical ranging event. Additionally, upon performing the historical ranging event, the at least one client device may report a ranging feedback message to the one or more APs or the WLC 204. The ranging feedback message may indicate a result of the historical ranging event. For example, the result of the historical ranging event may include the measurement of the distance between the at least one client device and an AP of the one or more APs and/or a ranging accuracy of the measurement. In an example, the ranging feedback message may include a Location Measurement Report (LMR). Similarly, upon performing each historical ranging event of the plurality of historical ranging events, the one or more APs of the set of APs 206-210 may report the ranging data, and the at least one client device may report the ranging feedback message. Upon receiving the ranging data and/or the ranging feedback messages, the WLC 204 may store, in the memory 204B, the received ranging data and/or the received ranging feedback messages as the historical ranging data.

In further embodiments, upon acquiring the historical ranging data, the WLC 204 may be configured to determine a count of the at least one client device based on client identifiers and/or a count of the ranging feedback messages included in the historical ranging data. Further, the WLC 204 may be configured to determine a ranging cadence of each AP of the set of APs 206-210 based on the outcome of each of the plurality of historical ranging events, the count of the at least one client device, and/or the count of the ranging feedback messages. “Ranging cadence” may refer to the frequency or timing interval at which ranging operation (e.g., FTM exchanges) may be performed between a station (STA) and an AP or a client device and an AP. In other words, the ranging cadence may indicate the count of the execution of the ranging operation within a specific time interval. In some more examples, if the historical ranging data is absent (or if the plurality of historical ranging events was not performed), the WLC 204 may determine a ranging cadence of each AP of the set of APs 206-210 based on predetermined data set uploaded by a developer or the like.

In still further embodiments, upon determining the ranging cadence of each AP of the set of APs 206-210, the WLC 204 may be configured to determine whether the ranging cadence of each AP of the set of APs 206-210 is greater than a ranging cadence threshold by comparing the ranging cadence of each AP of the set of APs 206-210 with the ranging cadence threshold. For example, the WLC 204 may determine that the ranging cadence may be greater than ranging cadence threshold in high-traffic zones (e.g., every few seconds) where frequent exchanges happen for better real-time location tracking, while the ranging cadence may be less than the ranging cadence threshold in less critical areas that require conservation of radio resources. For the embodiments shown in FIG. 2, the WLC 204 may determine that the ranging cadences of the first AP 206 and the second AP 208 are greater than the ranging cadence threshold. Upon determining that the ranging cadences of the first AP 206 and the second AP 208 are greater than the ranging cadence threshold, the WLC 204 may identify a geographical area serviced by each of the first AP 206 and the second AP 208 as the geographical zone 218.

In still yet further embodiments, upon identifying the geographical zone 218, the WLC 204 may be configured to select, from the plurality of radios 214A-214G, a first set of radios 214A-214E corresponding to the first AP 206 and the second AP 208. Upon selecting the first set of radios 214A-214E, the WLC 204 may be configured to obtain radio data associated with the first set of radios 214A-214E. The radio data may be received from the first AP 206 and the second AP 208 and/or may be maintained by the WLC 204. In an example, the radio data may include at least one of: an RF band associated with each radio of the first set of radios 214A-214E, bandwidth usage information of the data exchange operation associated with each radio of the first set of radios 214A-214E, or an RSSI associated with each radio of the first set of radios 214A-214E. The RF band of a specific radio of the first set of radios 214A-214E may indicate the specific frequency band (e.g., a 2.4 GHz band, a 5 GHz band, a 6 GHz band, or the like) supported by the specific radio. The bandwidth usage information of the specific radio may indicate a data traffic amount exchanged between the specific radio and a client device (e.g., the client device 212) while performing the data exchange operation. The RRSI associated with the specific radio may indicate a signal power (or signal strength) of a wireless signal of the client device 212 measured by the specific radio.

In further additional embodiments, upon obtaining the radio data, the WLC 204 may be configured to acquire second channel requirement information (also referred to as second RF-related requirements) associated with the ranging operation. In an example, the second channel requirement information may include at least one of: an indication of a specific channel width beyond which the ranging operation is optimal or an indication of a specific RSSI range within which the ranging operation is optimal. In an example, an upper and lower limits of the specific RSSI range may be lower than the RSSI requirements of the data exchange operation. Further, the WLC 204 may be configured to assign a weight to each radio of the first set of radios 214A-214E based on the obtained radio data and/or the acquired second channel requirement information. In an example, the WLC 204 may assign higher weights to one or more radios of the set of radios 214A-214E whose RF bands indicate the 5 GHz band and/or 6 GHz band in anticipation that these radios can support the specific channel width indicated in the second channel requirement information. For instance, an order of RF band-based weight assignment may be 6 GHz band >5 GHz band >2.4 GHz band. Further, the WLC 204 may assign higher weights to one or more radios of the set of radios 214A-214E whose data traffic amounts are lower than a data traffic threshold in anticipation that these radios are less utilized for the data exchange operation compared to other radios in the set of radios 214A-214E. Furthermore, the WLC 204 may assign higher weights to one or more radios of the set of radios 214A-214E whose RSSIs are within the specific RSSI range indicated by the second channel requirement information. In some more examples, the WLC 204 may assign a single composite weight to each radio of the set of radios 214A-214E based on the RF band associated with each radio of the first set of radios 214A-214E, the bandwidth usage information associated with each radio of the first set of radios 214A-214E, the RSSI associated with each radio of the first set of radios 214A-214E. The assignment of the single composite weight may be based on an order of preference of the RF band, the bandwidth usage information, and the RSSI. For instance, the order of preference may be the RF band>the bandwidth usage information>the RSSI.

In additional embodiments, upon assigning the weight to each radio of the first set of radios 214A-214E, the WLC 204 may be configured to select a second set of radios from the first set of radios 214A-214E. In order to select the second set of radios, the WLC 204 may be configured to determine whether the assigned weight of each radio of the first set of radios 214A-214E is greater than a weight threshold by comparing the assigned weight with the weight threshold. Further, the WLC 204 may select, from the first set of radios 214A-214E, the second set of radios whose assigned weights are greater than the weight threshold. For the embodiments shown in FIG. 2, the WLC 204 may select, among the first set of radios 214A-214E, the third radio 214C of the first AP 206 and the second radio 214E of the second AP 208 as the second set of radios.

In still additional embodiments, upon selecting the second set of radios 214C and 214E, the WLC 204 may be configured to allocate at least one second channel width to the second set of radios 214C and 214E based on the specific channel width included in the second channel requirement information, and/or the channel numbers and/or the channel widths included in the historical ranging data. In an example, the WLC 204 may allocate, as the second channel width, a channel width that is equal to or greater than the specific channel width in anticipation that the ranging operation can be executed in an optimal manner (e.g., a ranging accuracy associated with the ranging operation is greater than a ranging accuracy threshold). For example, the allocated second channel width may be different from the first channel width allocated for the data exchange operation since the data exchange operation requires a narrower channel width that minimizes the OBSS interference and the ranging operation requires a wider channel width that enables the ranging operation to be executed optimally. In some more examples, the WLC 204 may allocate the second channel width for the ranging operation by considering the first channel width allocated to the data exchange operation in anticipation that interference of two or more radios of the same AP is avoided. For instance, if the first channel width corresponds to a narrower channel width of 20 MHz, the WLC 204 may allocate, as the second channel width, a channel width of 40 MHz, a channel width of 80 MHz, or the like.

In still yet additional embodiments, upon allocating the second channel width, the WLC 204 may be configured to control the first AP 206 and the second AP 208 to operate the second set of radios 214C and 214E at the allocated second channel width. In an example, the WLC 204 may select a plurality of channels corresponding to the second channel width, and control the first AP 206 and the second AP 208 to operate the second set of radios 214C and 214E on the selected plurality of channels for the ranging operation. Further, upon allocating the second channel width, the WLC 204 may be configured to determine a third set of radios from the plurality of radios 214A-214G based on the second set of radios 214C and 214E. For example, the third set of radios may include radios of the plurality of radios 214A-214G excluding the second set of radios 214C and 214E. For the embodiments shown in FIG. 2, the third set of radios may include the first and second radios 214A and 214B of the first AP 206, the first radio 214D of the second AP 208, and the first and second radios 214F and 214G of the third AP 210. Upon determining the third set of radios, the WLC 204 may be configured to control the set of APs 206-210 to operate one or more radios of the third set of radios at the first channel width for the data exchange operation. Accordingly, for the embodiments shown in FIG. 2, the first AP 206 may operate a first subset of radios including the first and second radios 214A and 214B at the first channel width for the data exchange operation. Further, the first AP 206 may operate a second subset of radios including the third radio 214C at the second channel width for the ranging operation. Similarly, the second AP 208 may operate the first radio 214D at the first channel width for the data exchange operation, and the second radio 214E at the second channel width for the ranging operation.

In more embodiments, the WLC 204 may be configured to control the set of APs 206-210 to at least one of: transmit a ranging capability announcement or prohibit the transmission of the ranging capability announcement. For the embodiments shown in FIG. 2, the WLC 204 may control each of the first and second APs 206 and 208 to transmit the ranging capability announcement. Specifically, the WLC 204 may independently control the second set of radios 214C and 214E to transmit a first ranging capability announcement and a second ranging capability announcement, respectively. For example, the first ranging capability announcement may include an indication that the third radio 214C is configured for the ranging operation. In an example, the indication may include a Basic Service Set Identifier (BSSID) of the first AP 206, an identifier of the third radio 214C, and/or channel information associated with the third radio 214C. As used herein, the channel information may include the allocated channel width (e.g., the second channel width), the selected channel number for the allocated channel width, or the like. Similarly, the second ranging capability announcement may include an indication that the second radio 214E is configured for the ranging operation.

For the embodiments shown in FIG. 2, the WLC 204 may control the third set of radios of the set of APs 206-210 to prohibit the transmission of the ranging capability announcement since the third set of radios is configured for the data exchange operation. Additionally, the WLC 204 may control each radio of the third set of radios to transmit a data exchange capability announcement that includes an indication that a corresponding radio of the third set of radios is configured for the data exchange operation. Further, the WLC 204 may control the second set of radios 214C and 214E to prohibit the transmission of the data exchange capability announcement since the second set of radios 214C and 214E is configured for the ranging operation.

In still more embodiments, upon the transmission of the ranging capability and/or data exchange capability announcements, the set of APs 206-210 may be configured to receive one or more client requests from the client device 212. For example, the client requests may include a data exchange request, a ranging request, or the like. In an example, the client device 212 may transmit the client requests to an AP of the set of APs 206-210 if the client device 212 is located within a physical area serviced by the AP. In the embodiments shown in FIG. 2, the client device 212 may be located within the physical area serviced by the first AP 206 and/or the physical area serviced by the second AP 208. For example, the client device 212 may transmit, to the first AP 206, the data exchange request that requests for the execution of the data exchange operation. In an example, the data exchange request may include an identifier of at least one of the first radio 214A or the second radio 214B, channel requirement information associated with the data exchange operation, or the like.

Upon receiving the data exchange request, the first AP 206 may be configured to determine whether the first channel width, allocated to the first radio 214A and the second radio 214B, meets the channel requirement information. If the first channel width meets the channel requirement information, the first AP 206 may execute the data exchange operation with the client device 212 by operating at least one of the first radio 214A or the second radio 214B at the first channel width. Conversely, if the allocated first channel width does not meet the channel requirement information, the first AP 206 may report an indication that the allocated first channel width fails to meet the channel requirement information. Further, the WLC 204 may update the allocated first channel width in order to meet the channel requirement information. Additionally, if the first AP 206 receives the ranging request, the first AP 206 may execute the ranging operation with the client device 212 by operating the third radio 214C at the second channel width. In an example, the ranging request may include an indication requesting the execution of the ranging operation, an identifier (e.g., a MAC address) of the client device 212, or the like. For example, the ranging request may correspond to an FTM request.

In yet more embodiments, upon executing the data exchange operation and/or the ranging operation, the first AP 206 may be configured to receive one or more feedback messages from the client device 212. For example, the feedback messages may include a data exchange feedback message associated with the data exchange operation and/or a ranging feedback message associated with the ranging operation. Further, the first AP 206 may forward the received feedback messages to the WLC 204. In some more examples, the client device 212 may directly transmit the feedback messages to the WLC 204. In an example, the WLC 204 may receive the ranging feedback message associated with the third radio 214C. For example, the ranging feedback message may include a result of the execution of the ranging operation. The result of the execution of the ranging operation may include the measurement of distance between the client device 212 and the first AP 206, a ranging accuracy of the measurement, or the like. For instance, the ranging feedback message may correspond to an LMR.

Upon receiving the ranging feedback message, the WLC 204 may be configured to compare the ranging accuracy of the measurement with the ranging accuracy threshold to obtain a first comparison result. The first comparison result may indicate one of: the ranging accuracy is lower than the ranging accuracy threshold, the ranging accuracy is equal to the ranging accuracy threshold, or the ranging accuracy is greater than the ranging accuracy threshold. Further, the WLC 204 may determine, based on the first comparison result, whether the ranging accuracy of the measurement is lower than the ranging accuracy threshold. For example, if the ranging accuracy is not lower than the ranging accuracy threshold, the WLC 204 may increase the assigned weight of the third radio 214C. Conversely, if the ranging accuracy is lower than the ranging accuracy threshold, the WLC 204 may reduce the assigned weight of the third radio 214C.

Upon reducing the weight of the third radio 214C, the WLC 204 may be configured to compare the reduced weight of the third radio 214C with the weight threshold to obtain a second comparison result. The second comparison result may indicate one of: the reduced weight is lower than the weight threshold, the reduced weight is equal to the weight threshold, the reduced weight is greater than the weight threshold. Further, the WLC 204 may be configured to determine, based on the second comparison, whether the reduced weight is lower than the weight threshold. For example, if the reduced weight is lower than the weight threshold, the WLC 204 may be configured to remove the third radio 214C from the second set of radios 214C and 214E. Conversely, if the reduced weight is not lower than the weight threshold, the WLC 204 may be configured to retain the third radio 214C in the second set of radios 214C and 214E.

In still yet more embodiments, the WLC 204 may be configured to receive the data exchange feedback message associated with the first radio 214A in addition to the reception of the ranging feedback message. In an example, the data exchange feedback message may include a result of the execution of the data exchange operation. For example, the result of the execution of the data exchange operation may include an accuracy of the data exchange operation indicating whether the data exchange operation was executed with the required data throughput or the like. Upon receiving the data exchange feedback message and the ranging feedback message, the WLC 204 may analyze the result of the ranging operation in relation to the result of the data exchange operation to determine whether the ranging operation was executed with the ranging accuracy threshold, without compromising the accuracy of the data exchange operation. For example, if the ranging operation was executed with the ranging accuracy threshold without compromising the accuracy of the data exchange operation, the WLC 204 may utilize the allocated first and second channel widths to handle one or more further client requests received from the client device 212.

In some more embodiments, if the ranging operation was not executed with the ranging accuracy threshold, the WLC 204 may be configured to modify the allocated second channel width. The modification of the allocated second channel width may include at least one of: increasing or decreasing the allocated second channel width by a first specific channel width value. In an example, the WLC 204 may increase or decrease the allocated second channel width by the first specific channel width value in anticipation that the ranging accuracy of the ranging operation matches the ranging accuracy threshold. For example, if the allocated second channel width corresponds to the 160 MHz channel width, the WLC 204 may update the allocated second width to the 80 MHz channel width (or the 40 MHz channel width) in order to match the ranging accuracy of the ranging operation to the ranging accuracy threshold.

In several embodiments, the data exchange feedback message may further include an indication indicating new first channel requirement information. Upon receiving the new channel requirement information, the WLC 204 may be configured to modify at least one of the allocated first channel width or the allocated second channel width. For example, the first channel requirement information may include new data throughput that is greater than the specific data throughput. Upon receiving the new data throughput, the WLC 204 may be configured to increase the allocated first channel width by a second specific channel width value in order to match the new data throughput. For instance, if the allocated first channel width corresponds to the 20 MHz channel width, the WLC 204 may update the allocated first channel width to the 40 MHz channel width. In some more examples, upon modifying the allocated first channel width, the WLC 204 may modify the allocated second channel width in order to simplify the channel selection process and/or to avoid the interference from radios of the same AP. In an example, if the allocated second channel width corresponds to the 40 MHz channel width, the WLC 204 may update the allocated second channel width to the 80 MHz channel width.

In this way, the WLC 204 may be configured to dynamically allocate the first and second channel widths to the plurality of radios 214A-214G by incorporating the first channel requirement information and the second channel requirement information. In an example, the first and second channel widths may be allocated in such a way that the data exchange operation and the ranging operation are executed in an optimal manner (e.g., the ranging operation is executed with the ranging accuracy threshold, without compromising the accuracy of the data exchange operation). For example, the WLC 204 may ensure that both the data exchange and ranging operations are executed in the optimal manner by allocating the wider channel width to one set of radios (e.g., the second set of radios 214C and 214E) of the plurality of radios 214A-214G for the ranging operation and the narrower channel width to another set of radios (e.g., the third set of radios) of the plurality of radios 214A-214G for the data exchange operation. Further, the allocation of the wider and narrower channel widths to the plurality of radios 214A-214G may enable the WLC 204 to suppress inefficiencies in channel width allocation that could lead to suboptimal performance in one or both the data exchange and ranging operations.

In several more embodiments, the WLC 204 may be configured to utilize a Machine learning (ML) model to allocate the first channel width and the second channel width to the plurality of radios 214A-214G. For example, the ML model may include a reinforcement learning model, a neural network (NN), a deep neural network (DNN), a generative model, or the like. In an example, the ML model may be pre-trained using one or more training data sets to allocate the first channel width and the second channel width to the plurality of radios 214A-214G. For instance, the training data sets may include the historical ranging data associated with the set of APs 206-210, the first channel requirement information, the second channel requirement information, or the like.

Although a specific embodiment of the indoor environment 202 is described above with respect to FIG. 2, any of a variety of systems and/or processes may be utilized in accordance with embodiments of the disclosure. For example, the RRM logic 216 may be embodied in at least one AP of the set of APs 206-210. The at least one AP may be configured to dynamically allocate the first and second channel widths to the plurality of radios 214A-214G of the set of APs 206-210 for the data exchange operation and the ranging operation. The elements depicted in FIG. 2 may also be interchangeable with other elements of FIG. 1 and FIGS. 3-13 as required to realize a particularly desired embodiment.

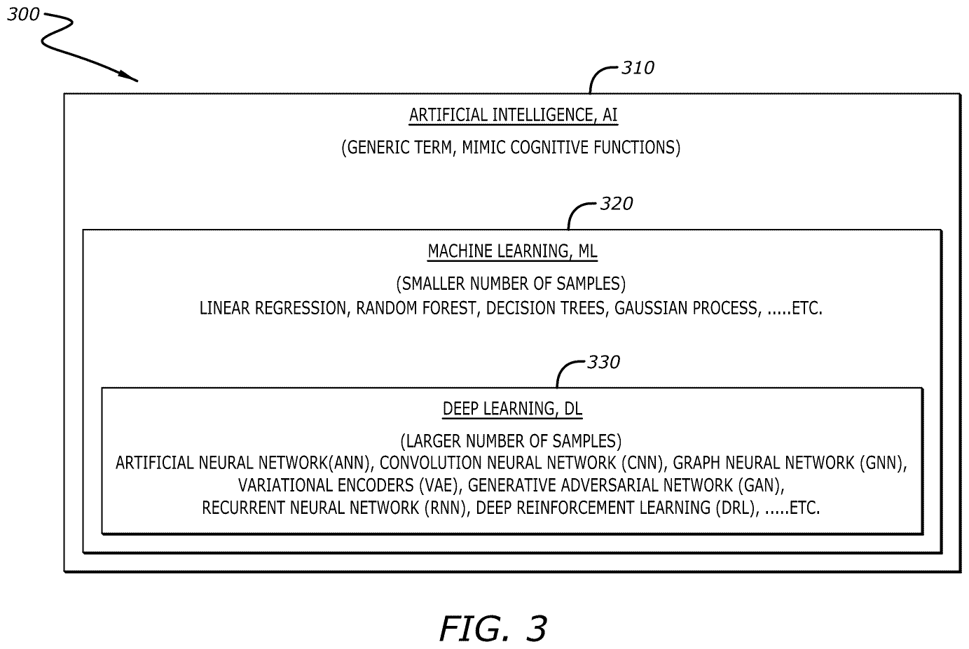

Referring to FIG. 3, a diagram 300 depicting various subsets of artificial intelligence in accordance with various embodiments of the disclosure is shown. Artificial intelligence (AI) 310 is typically understood in the art to be the development of machines and algorithms that mimic human intelligence, for example, by optimizing actions to achieve certain goals. At its core, AI 310 often involves designing algorithms and models that mimic cognitive functions, such as learning, reasoning, problem-solving, perception, and even language understanding. Unlike traditional computer programs that follow a fixed set of instructions, AI systems have the ability to adapt, improve, and make decisions based on input data and environmental interactions.

AI 310 can be considered a generic term because it encompasses a wide range of subfields and techniques, from simple rule-based systems to advanced machine learning and deep learning models. These AI techniques are used to simulate various aspects of human cognition. For example, ML 320 allows computers to learn from data patterns without explicit programming for each task, while natural language processing (NLP) enables machines to understand and generate human language. Deep learning (DL) 330, a more advanced branch of AI, uses neural networks to automatically learn complex patterns from large datasets, akin to the human brain's information processing. This versatility makes AI a powerful tool across diverse applications, including image recognition, autonomous driving, voice assistants, healthcare diagnostics, and materials discovery.

A goal of AI is often to create systems that can function autonomously and intelligently in real-world scenarios. As the AI 310 continues to evolve, it can increasingly mirror human-like cognition, enabling machines to not just process data but to “think” in a way that can handle uncertainty, make predictions, and even interact with their surroundings in a meaningful manner. While AI systems are far from achieving the full breadth of human intelligence, their ability to replicate specific cognitive functions makes them invaluable in tackling complex, data-driven challenges.

ML 320 is a subset of AI 310 that focuses on the development of algorithms and statistical models that enable computers to learn and make decisions from data without explicit programming. In traditional programming, a computer is given a fixed set of rules to follow, but ML 320 can shift this paradigm by allowing systems to identify patterns, adapt, and improve their performance based on the data they encounter. This data-driven approach makes ML particularly valuable for tasks that are too complex or dynamic to define using straightforward rules, such as, for example, recognizing images, predicting consumer behavior, or diagnosing diseases. In various embodiments described herein, machine-learning methods may be utilized to dynamically allocate the first channel width and the second channel width for the data exchange operation and the ranging operation, respectively, in a network including a set of APs. For example, the first and second channel widths may be allocated to a plurality of radios of the set of APs.

ML models can be configured to analyze large amounts of data to identify trends and relationships that inform their predictions or classifications. The process typically involves three stages: training, validation, and testing. During training, the model learns from a dataset by adjusting its internal parameters to minimize errors between its predictions and the actual results. Techniques like linear regression, decision trees, random forests, and Gaussian processes are commonly used in ML 320. These algorithms can handle various data types, including numerical, categorical, and structured datasets like spreadsheets or grids. One of the key strengths of ML is its ability to generalize from the training data to make accurate predictions on new, unseen data. In a number of embodiments described herein, training data may be generated from historical ranging events between the set of APs and one or more client devices, developer inputs, quality assurance/testing feedback, among other sources.

However, traditional ML methods rely heavily on feature engineering, wherein human experts manually identify the most relevant features or patterns within the data. For example, when using ML 320 for channel width allocation, an expert might need to extract features like past allocated channel widths, past selected channels, or the like before feeding them into a model. This requirement can limit the scalability of traditional ML approaches, especially when dealing with large, unstructured datasets. Additionally, ML algorithms may often work best when provided with relatively structured data, and they often need a reasonable number of samples (typically more than 100) to learn effectively.

DL 330 is a specialized subset of ML 320 that employs multi-layered artificial neural networks to automatically learn complex patterns and representations from large, often unstructured datasets. Inspired by the way the human brain processes information, DL 330 consists of interconnected layers of “neurons” that can adaptively change as they are exposed to more data. Unlike traditional ML methods, which require manual feature engineering to identify key data characteristics, DL models can automatically extract features directly from raw data. This automated feature extraction allows DL 330 to handle data types and tasks that were previously difficult or impossible for ML models to tackle effectively.

DL models, including Convolutional Neural Networks (CNNs), Graph Neural Networks (GNNs), and Recurrent Neural Networks (RNNs), excel at processing various forms of data. CNNs are particularly effective for image analysis, recognizing intricate patterns in visual inputs, making them indispensable in areas like materials science for analyzing microscopic images or detecting defects in materials. GNNs, on the other hand, are designed to work with graph-based data, such as molecular structures, social networks, or atomic interactions. They can learn the dependencies and relationships within graph-like structures, which is required for predicting properties of complex molecules and materials. RNNs and their variants, such as Long Short-Term Memory (LSTM) networks, are suited for sequential data like time series or natural language processing, allowing for the analysis and generation of textual information or the prediction of temporal patterns in scientific research.

One of the defining characteristics of deep learning is its requirement for large datasets (typically over 500 samples for example) to effectively train neural networks. The deep, multi-layered structure of these networks enables them to capture highly complex and abstract representations of the data, but it also demands significant computational power. Techniques like Variational Autoencoders (VAEs) and Generative Adversarial Networks (GANs) add to the versatility of DL by enabling the generation of new data samples that resemble the training set, aiding in areas such as materials discovery and synthetic data creation. Deep Reinforcement Learning (DRL) combines neural networks with decision-making processes to solve problems that involve optimization and control, further expanding DL's application potential. In summary, DL's ability to automatically learn from raw, unstructured data and model intricate patterns makes it a powerful tool in AI, particularly for complex domains like image recognition, natural language processing, and materials science.

Artificial Neural networks (ANNs or sometimes just NNs) are often a foundation of a DL system. The basic unit of a neural network is typically the perceptron, which can take inputs, assigns weights to these inputs, and combines them to produce an output. The final output is then passed through an activation function (such as, for example, ReLU, sigmoid, or hyperbolic tangent) to introduce non-linearity, which enables the network to model complex patterns.

Neural networks are typically trained through a process of backpropagation, where the system's predictions are compared against the known output, and a loss function is used to measure the difference between the prediction and the actual result. The network's weights can be adjusted through a process called gradient descent, which can be configured to minimize the loss function over time. However, the training process can be prone to problems like overfitting (where the model performs well on the training data but poorly on new data). To counter this, techniques such as regularization (e.g., regularization, dropout), early stopping, and mini-batches can be utilized to prevent the network from becoming overly specialized to the training set.

CNNs are a specific type of ML neural network designed to work well with any kind of input data. For example, the input data may include ranging data associated with the historical ranging events, the first channel requirement information associated with the data exchange operation, the second channel requirement information associated with the ranging operation, a density of one or more client devices, association information associated with the client devices relative to the set of APs, or the like. As those skilled in the art will recognize, CNNs typically use specialized layers known as convolutional layers, which apply filters (also known as kernels) to the input data. These filters slide over the input data, detecting patterns (the past allocated channel widths, the past selected channels, or the like), which are then passed to the next layer for further processing. The advantage of CNNs is their ability to automatically learn and extract relevant features from raw data without the need for manual feature engineering. After several layers of convolutions, the CNN can output a prediction, such as the allocation of at least one of the first channel width or the second channel width to the set of APs for at least one of the data exchange operation or the ranging operation, respectively.

In many embodiments, the CNNs may encompass Graph Neural Networks (GNNs) that are designed to work particularly well with graph-based input data. In these embodiments, the input data may be converted into the graph-based input data. In order to convert the input data into the graph-based input data, the input data may be represented as a graph, where nodes represent entities (e.g., the set of APs and/or the client devices) and edges represent relationships between the entities (e.g., the past allocated channel widths, the past selected channels, outcomes of the plurality of the historical ranging events, associations of the client devices to the set of APs, or the like).

In GNNs, information is passed between nodes through edges in a process called message passing. This allows the network to capture dependencies and relationships within the graph structure. The key feature of GNNs is their ability to aggregate information from neighboring nodes, which is required in predicting properties that depend on the current/local structure, such as the past allocated channel widths to the set of APs for the ranging operation.

Generative models aim to learn the underlying distribution of a dataset and generate new samples that resemble the original data. Two common types of generative models are Variational Autoencoders (VAEs) and Generative Adversarial Networks (GANs). VAEs are often configured to work by encoding data into a lower-dimensional latent space and then decoding it back into its original form. This allows for the generation of new data by sampling points from the latent space. This can be utilized when attempting to allocate the first channel width and the second channel width to the set of APs for the data exchange and ranging operations or the like.

Similarly, GANs consist of two components: a generator that creates fake/generated data and a discriminator that tries to distinguish between real and fake data. The two components are trained in a competitive process where the generator tries to “fool” the discriminator, leading to increasingly realistic generated data. This type of process may be utilized to compare the output of the channel width allocations to one or more realistic channel width allocations.

Reinforcement Learning (RL) involves an agent learning to make decisions by interacting with an environment and receiving feedback (rewards or penalties) based on its actions. Deep Reinforcement Learning (DRL) combines RL with DL techniques, allowing agents to learn from the input data.

In the network including the set of APs and the client devices, DRL can be used in scenarios where an optimal decision needs to be made, such as optimizing the channel width allocations to the set of APs for the data exchange and ranging operations or optimizing the channel selection for the set of APs based on the desired or current properties of the set of APs and/or the client devices. The combination of RL and DL can allow for learning from raw data, making it a powerful tool for dynamic and real-time decision-making within the network.

Although a specific embodiment for a diagram 300 depicting various subsets of artificial intelligence suitable for carrying out the various steps, processes, methods, and operations described herein is discussed with respect to FIG. 3, any of a variety of systems and/or processes may be utilized in accordance with embodiments of the disclosure. For example, other subset may be present and available for use within AI 310. Those skilled in the art will recognize that the diagram 300 presented in FIG. 3 is simplified for illustration purposes and various methods and techniques may interact with other areas (ML 320 with DL 330, etc.). The elements depicted in FIG. 3 may also be interchangeable with other elements of FIGS. 1-2 and 4-13 as required to realize a particularly desired embodiment.

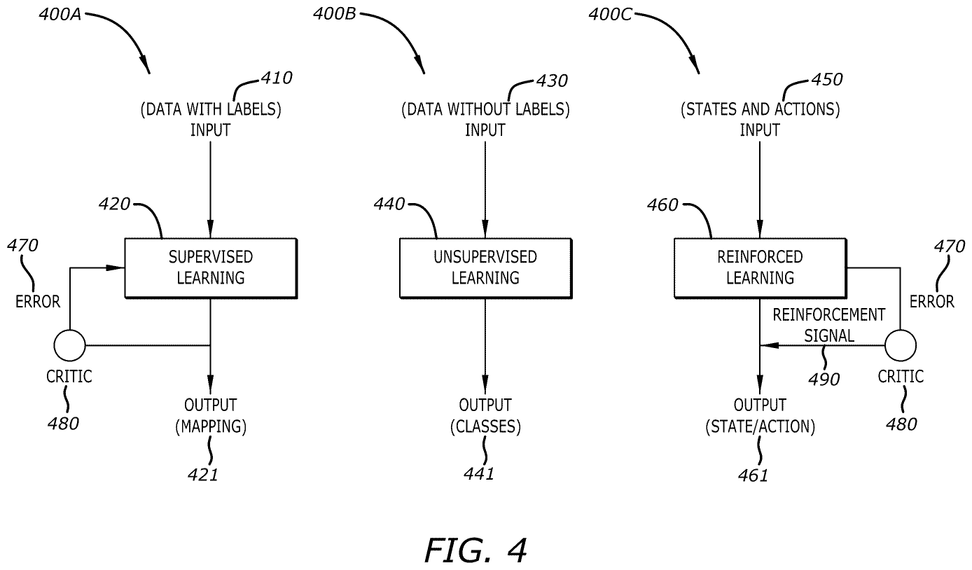

Referring to FIG. 4, different methods of machine-based learning in accordance with various embodiments of the disclosure are shown. In many embodiments, an ML model is defined as a mathematical representation of the output of the training process. An ML model is often considered similar to computer software designed to recognize patterns or behaviors based on previous experience or data. However, the learning algorithm can discover patterns within the training data, and output an ML model which can capture these patterns and make predictions on new data.

ML models can be understood as a device that has been trained to find patterns within new data and make predictions. These models can be represented as a complex mathematical function that would be impractical for a human to calculate that takes requests in the form of input data, makes predictions on input data, and then provides an output in response. First, these models can be trained over a set of data, and then they are provided an algorithm or other task to reason over data, extract the pattern from feed data and learn from that data. Once the model(s) is/are trained, they can be used to predict a new and previously unseen dataset.

There are various types of machine learning models available based on different business goals and data sets available. Often, based on the desired application, ML models can be configured as or settle into one of three different model types: supervised learning, unsupervised learning, and/or reinforcement learning. Supervised learning can further be broken down into two categories of classification and regression. Likewise, unsupervised learning can be divided into three categories: clustering, association rule, and/or dimensionality reduction.

In the embodiment depicted in FIG. 4, a supervised learning system 400A is shown. The supervised learning system 400A can be configured with a supervised learning model 420 that accepts input data 410 and generates an output 421. However, the output data is often reviewed by a critic 480 that can determine one or more errors 470 that are fed back into the supervised learning model 420, as a reinforcement signal 490, for use in updating.

Supervised learning systems 400A are often considered the simplest machine learning model to understand in which input data (such as training data) has a known label or result as an output. So, the supervised learning model 420 can be understood to work on the principle of input-output pairs. As such, a function can be trained using a training data set, which is then applied to unknown data and makes some predictive performance. Supervised learning is task-based and mostly tested on labeled data sets.

Supervised learning systems 400A may often involve one or more regression problems. In regression problems, the output is a continuous variable. Some commonly used Regression models include linear regression, decision trees, and random forests. Linear regression is typically the most straight forward machine learning model in which a prediction of one output variable is made using one or more input variables. The representation of linear regression can be processed as a linear equation, which combines a set of input values (denoted as x) and a predicted output (denoted as y) for the set of those input values. As those skilled in the art will recognize, this may be represented in the form of a line: Y=bx+c. A typical aim of a linear regression-based model can be to find the optimal fit line that best fits the available data points. Linear regression can be extended to multiple linear regressions (finding a plane of best fit in higher dimensional space) and polynomial regressions (finding the best fit curve).

Decision trees are also popular machine learning models that can be used for both regression and classification problems. A decision tree uses a tree-like structure of decisions along with their possible consequences and outcomes. In this, each internal node is used to represent a test on an attribute while each branch is used to represent the outcome of the test. The more nodes a decision tree has, the more accurate the result will be. This may be used when making decisions related to the allocation of the first and second channel widths to a set of APs for the data exchange and ranging operations, respectively. The advantage of decision trees is that they are intuitive and easy to implement, but may lack accuracy depending on the available computational or time resources available.

Random forests are an ensemble learning method, which may consist of a large number of decision trees. For example, each decision tree in a random forest predicts an outcome, and the prediction with the majority of votes is considered as the outcome. A random forest model can be used for both regression and classification problems. For the classification task, the outcome of the random forest may be taken from the majority of votes. Whereas in the regression task, the outcome can be taken from the mean or average of the predictions generated by each tree.

Classification models are the another type of supervised learning, which can be used to generate conclusions from observed values in one or more categorical forms. For example, a classification model can identify whether first channel width is suitable for the data exchange operation; whether the second channel width is suitable for the ranging operation, etc. Classification algorithms can also be used to predict between two or more classes and/or categorize an output into different groups. For these classification systems, a classifier model can be designed that classifies the dataset into different categories, and each category can subsequently be assigned a label. As those skilled in the art will recognize, there are currently two main types of classifications in machine learning: binary and multi-class. Binary classification can be utilized when there are only two possible classes (i.e., yes/no, dog/cat, etc.). Multi-class classification can be utilized when there are more than two possible classes, thus requiring a multi-class classifier.

One of the potential classification processes is logistic regression. Logistic regression can be used to solve various classification problems in machine learning systems. These processes are similar to linear regression but are often used to predict categorical variables. While some variations can be configured to generate a prediction as an output in either “yes” or “no”, 0 or 1, “true” or “false”, etc. However, in some embodiments, the system can instead be configured to not give exact values, but instead provide probabilistic values between zero and one, etc.

Another classification process that can be utilized is a support vector machine (SVM) which is widely used for classification and regression tasks. However, the main aim of SVM is to find the best decision boundaries in an N-dimensional space, which can be utilized to segregate data points into classes, and generate a best decision boundary often known as a hyperplane. SVM processes can select the extreme vector to find a hyperplane, wherein these vectors are known as support vectors.

Naïve Bayes is another popular classification algorithm used in machine learning. This process receives its name as it is based on Bayes theorem and follows the naïve (independent) assumption between the features which is often given as the formula:

$$P ( y \vert X ) = \frac{P ( X \vert y ) * P ( y )}{P ( X )}$$

This formula takes a class or target y and a predictor attribute (X) and calculates a posterior probability P(y|X) of that class given a particular predictor. P(y) is the prior probability of that class, P(X) is the prior probability of the predictor, and P(X|y) is the likelihood or probability of the predictor given the class. As those skilled in the art will recognize, this may be more succinctly understood as the posterior chance being a result of the prior results times the likelihood divided by the evidence available. Each naïve Bayes classifier assumes that the value of a specific variable is independent of any other variable/feature. For example, if a fruit needs to be classified based on color, shape, and taste. So yellow, oval, and sweet will be recognized as mango. Here each feature is independent of other features. Likewise, various embodiments herein can perform the classification based on the first channel requirement information associated with the data exchange operation, the second channel requirement information associated with the ranging operation, etc.

Again, in the embodiment depicted in FIG. 4, an unsupervised learning system 400B is shown. The unsupervised learning system 400B can be configured with an unsupervised learning model 440 that accepts input data 430 and generates an output 441. Unlike other model types, there are no critics or error signals to process. Unsupervised learning models 440 can implement the learning process opposite to supervised learning, which means it enables the model to learn from an unlabeled training dataset. Based on the unlabeled dataset, the unsupervised learning model 440 can predict the output. Using an unsupervised learning system 400B, the unsupervised learning model 440 can learn hidden patterns from the dataset by itself without any supervision. In various embodiments, unsupervised learning models 440 are often utilized to perform tasks involving clustering, association rule learning, and/or dimensional reduction.

Clustering is an unsupervised learning technique that involves clustering or grouping the available data points into different clusters based on similarities and/or differences. The objects or data points with the most similarities remain in the same group, and they have no or very few similarities from other groups. Clustering algorithms can be used in a variety of different tasks such as, but not limited to image segmentation, statistical data analysis, market segmentation, and the like. Some commonly used clustering algorithms that can be selected include K-means Clustering, hierarchal Clustering, DBSCAN, etc.

Association rule learning is an unsupervised learning technique which finds unique relations among variables within a large data set. In many embodiments, a primary aim of this type of learning algorithm is to find the dependency of one data item on another data item and map those variables accordingly so that it can satisfy some desired outcome. For example, in certain embodiments, an association rule system may be utilized to identify past allocated channel widths that resulted in successful ranging events. This algorithm can be applied in market basket analysis, web usage mining, continuous production, etc. However, those skilled in the art will recognize that other scenarios may be available based on the desired application. Some popular algorithms of association rule learning are Apriori Algorithm, Eclat, and FP-growth algorithm.

In additional embodiments, the number of features/variables present in a dataset can be understood as the dimensionality of the dataset, and the technique used to reduce the dimensionality is known as a dimensionality reduction technique. Although more data provides more accurate results, it can also affect the performance of the model/algorithm, such as yielding overfitting outcomes, etc. In such cases, dimensionality reduction techniques can be utilized. It is often desired that this process involves converting the higher dimensions dataset into lesser dimensions dataset while also ensuring that the ensuing results provide similar information. Different dimensionality reduction methods can be utilized, such as, but not limited to, PCA (Principal Component Analysis), Singular Value Decomposition (SVD), etc.

Finally, in the embodiment depicted in FIG. 4, a reinforcement learning system 400C is shown. The reinforcement learning system 400C can be configured with a reinforcement learning model 460 that accepts input data 450 and generates an output 461. In reinforcement learning, the reinforcement learning model 460 learns actions for a given set of states that lead to a goal state. In the embodiment depicted in FIG. 4, a critic 480 can receive or otherwise notice an error 470 within the reinforcement learning model 460 actions, and adjust the outcome/output such that the “reward” or “punishment” is adjusted to better model the future behaviors or processing of the reinforcement learning model 460.

It is a feedback-based learning model that can take feedback signals after each state or action by interacting with the environment. This feedback works as a reward (positive for each good action and negative for each bad action), and the agent's goal is to maximize the positive rewards to improve their performance. The behavior of the model in reinforcement learning is similar to human learning, as humans learn things by experiences as feedback and interact with the environment. Popular methods of reinforcement learning including q-learning, state-action-reward-state-action (SARSA), and deep Q network.

Q-learning is one of the popular model-free algorithms of reinforcement learning, which is based on the Bellman equation. It often aims to learn the policy that can help the AI agent to take the best action for maximizing the reward under a specific circumstance. It can incorporate Q values for each state-action pair that indicate the reward to following a given state path, and it tries to maximize that Q-value.

SARSA is an on-policy algorithm based on the Markov decision process. In many embodiments, it can use the action performed by the current policy to learn the Q-value. The SARSA algorithm stands for State Action Reward State Action, which symbolizes the tuple (s, a, r, s′, a′). Finally, deep Q neural networking (or DQN) is Q-learning within a neural network. It can be deployed within a big state space environment where defining a Q-table would be a complex task. So, in these embodiments, rather than using a Q-table, the neural network instead utilizes Q-values for each action based on the state.

Although a specific embodiment for different methods of machine-based learning suitable for carrying out the various steps, processes, methods, and operations described herein is discussed with respect to FIG. 4, any of a variety of systems and/or processes may be utilized in accordance with embodiments of the disclosure. For example, those skilled in the art will recognize that methods of learning described herein are generalized and may incorporate other types developed as well as a combination of one or more methods based on the goals of the desired application. The elements depicted in FIG. 4 may also be interchangeable with other elements of FIGS. 1-3 and 5-13 as required to realize a particularly desired embodiment.

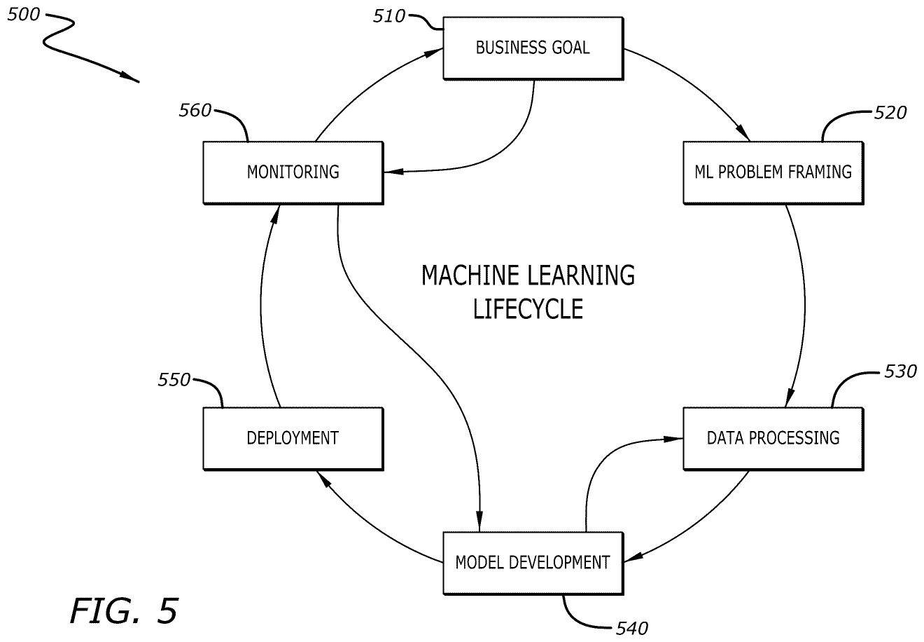

Referring to FIG. 5, a machine learning lifecycle 500 in accordance with various embodiments of the disclosure is shown. During the development of machine learning systems, the embodiment depicted in FIG. 5 can provide a framework for how to structure the design and maintenance of these systems. This machine learning lifecycle 500 outlines various stages involved in building, deploying, and improving ML models to solve real-world problems. By following this structured process, businesses and organizations can ensure that their machine learning projects align with strategic goals, use data effectively, and adapt to changing conditions over time. This machine learning lifecycle 500 emphasizes that developing a machine learning model is not a one-time effort but an iterative process requiring ongoing monitoring and adjustment. The feedback loop inherent in the machine learning lifecycle 500 allows for continual refinement and optimization of models to maintain their accuracy and relevance.

In many embodiments, a first stage of the machine learning lifecycle 500 is identifying the business goal 510, which sets the overall direction and purpose of the ML project. This can involve understanding the specific problems or opportunities within the business or project that machine learning can address. A clear business goal 510 ensures that the project remains focused on delivering tangible value, whether it is optimizing channel widths (or channels) of a set of APs for the data exchange and ranging operations. Without a well-defined goal, it can be challenging to align the subsequent stages of the ML lifecycle 500, as the choice of model, data processing methods, and performance metrics can all depend on what the business aims to achieve.

Establishing a proper business goal 510 can also involve engaging with key stakeholders and developers to gather requirements and set success criteria. It can provide a roadmap that outlines what success looks like and helps in framing the ML problem. For example, if the goal is to allocate an optimal channel width for the ranging operation, the project might focus on building a predictive model that identifies potential bottlenecks, allowing an RRM engine to intervene proactively. Clearly defined goals not only help guide the project but also provide benchmarks for evaluating the effectiveness of the deployed model once it enters production.

Once the business goal 510 is established, various embodiments take a next step involving ML problem framing 520, wherein the goal is translated into a specific machine learning task. This can involve selecting the appropriate type of ML problem, such as classification, regression, clustering, or recommendation, and defining the target variables or outputs. For example, if the goal is to identify the bottlenecks, the problem can be framed as a binary classification task where the model predicts whether a certain number of APs will cause the RRM engine to slow down. Proper problem framing can be important as it determines the particular data requirements, choice of model, and evaluation metrics.

During this stage, it is also prudent to consider the constraints and assumptions that may affect the model's development. This might include data availability, computational resources, ethical considerations, or regulatory compliance. Properly framing the problem ensures that the model development aligns with the business's needs and that the problem is broken down into manageable steps, ultimately increasing the project's chances of success.

Data processing 530 is a step in many embodiments where raw data is collected, cleaned, and transformed into a format suitable for machine learning. This step can involve gathering data from various sources, removing errors or inconsistencies, handling missing values, and normalizing or scaling features to ensure that the model can learn effectively. Feature engineering is often a part of this stage, where new features are derived from the raw data to capture more relevant information and improve model performance.

The quality and preparation of the utilized data can significantly impact the model's accuracy and reliability. Inadequate or poorly processed data can lead to biased or inaccurate predictions, no matter how advanced the model is. Hence, data processing 530 can require or at least benefit from careful planning and iterative refinement. Once the data is processed, it is typically split into training, validation, and test sets to develop and evaluate the model, ensuring that it generalizes well to new, unseen data.

Model development 540 is a phase in a number of embodiments where machine learning algorithms are selected, trained, and refined to create a model that addresses the framed problem. This stage can involve choosing the appropriate algorithm (e.g., decision trees, neural networks, support vector machines), setting up the model's architecture, and defining hyperparameters that will guide the training process. The model is trained on the processed data to identify patterns and relationships that allow it to make predictions or decisions.

During model development 540, the model can be evaluated using the validation dataset to fine-tune its parameters and improve performance. Techniques like cross-validation, regularization, and hyperparameter tuning can be used to prevent overfitting and ensure the model generalizes well. If proper steps are taken, the result is a model that, once it meets predefined performance metrics, is ready for deployment in a real-world environment. However, this process often involves several iterations to optimize the model for the specific business goal, indicated by the arrow back to data processing 530.

In further embodiments, deployment 550 is the stage where the developed model is integrated into the production environment to perform its intended tasks. This phase may involve setting up the necessary infrastructure, such as APIs or cloud-based services, to allow the model(s) to process live data and generate predictions. Deployment 550 can transform the model from a research tool into a functional component of a business process or product, providing real-time insights, automations, or decisions.

Proper deployment 550 can also include setting up mechanisms for logging, error handling, and user access. Since real-world environments are often dynamic and differ from training conditions, deployment may require continuous adaptation and updates to ensure the model(s) operates efficiently. This step can be important because a model's success is not only determined by its performance metrics but also by its ability to provide actionable results that align with the business goal 510.

In more embodiments, monitoring 560 is the ongoing process of tracking the model's performance and behavior after deployment. It involves collecting data on the model's predictions, accuracy, latency, and error rates to detect issues such as concept drift, where changes in the underlying data patterns can degrade the model's accuracy. By continuously monitoring 560, teams can identify when the model's performance drops and requires retraining or adjustments to align with the evolving data.

Monitoring 560 can also encompass aspects like user feedback, security, and compliance, ensuring that the model remains effective, reliable, and ethical in its application. It may serve as the feedback loop in the lifecycle, where insights gained from monitoring feed back into the earlier stages, particularly data processing 530 and model development 540, to refine the model(s) as needed. This iterative process allows the machine learning system to adapt and maintain its alignment with the original business goal 510 over time.

Although a specific embodiment for a machine learning lifecycle 500 suitable for carrying out the various steps, processes, methods, and operations described herein is discussed with respect to FIG. 5, any of a variety of systems and/or processes may be utilized in accordance with embodiments of the disclosure. For example, the particular route of development of the model(s) may not follow this cycle completely. As those skilled in the art will recognize, there are a variety of ways to develop AI products that include various iterative steps that aide in development and refinement of different model(s). The elements depicted in FIG. 5 may also be interchangeable with other elements of FIGS. 1-4 and 6-13 as required to realize a particularly desired embodiment.

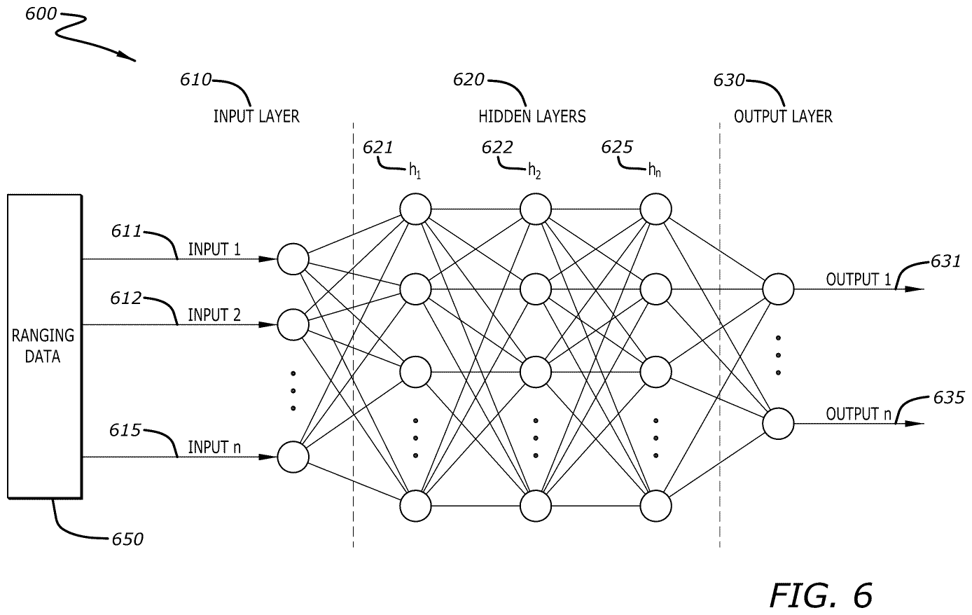

Referring to FIG. 6, an exemplary neural network 600 in accordance with various embodiments of the disclosure is shown. The embodiment depicted specifically depicts a feedforward neural network with multiple layers. This type of network consists of an input layer 610, one or more hidden layers 620, and an output layer 630. Each layer contains nodes (or neurons) that are interconnected, representing how data flows through the network. The input layer 610 can receive raw data, which is then processed by the hidden layers 620 through weighted connections and activation functions. These hidden layers 620 can enable the network to learn complex patterns and relationships within the data.

The final output layer 630 produces the network's predictions or classifications based on the processed input. The interconnected nature of the nodes allows the neural network 600 to learn from data during training by adjusting the weights of connections to minimize prediction errors. This structure is the foundation of deep learning models, as adding more hidden layers 620 can create a deep neural network, capable of tackling highly complex tasks such as channel width allocation (or channel selection) for the data exchange and ranging operations, natural language processing, and pattern detection in large datasets.

A perceptron or a single artificial neuron is the building block of artificial neural networks (ANNs) and can perform forward propagation of information. For a set of inputs to the perceptron, weights (and biases to shift wights) can be assigned. These inputs and weights can be multiplied out correspondingly together to get a sum output. Those skilled in the art will recognize tools such as, but not limited to, PyTorch, Tensorflow, and MXNet as training packages for common neural network tasks. However, it is contemplated that other tools may be developed specifically for the neural network tasks related to the embodiments described herein.

In additional embodiments, the weight matrices of a neural network can be initialized randomly or obtained from a pre-trained model. These weight matrices can be multiplied with the input matrix (or output from a previous layer) and subjected to a nonlinear activation function to yield updated representations, which are often referred to as activations or feature maps. The loss function (also known as an objective function or empirical risk) can often be calculated by comparing the output of the neural network and the known target value data.

Feedforward networks, such as the neural network 600 depicted in the embodiment of FIG. 6, are often configured as neural networks where information moves in one direction, from the input layer through the hidden layers to the output layer, without any cycles or loops. They are primarily used for tasks such as classification, regression, and simple pattern recognition, where each input is processed independently of others. In contrast, backpropagation is not a separate type of network but rather a training algorithm commonly used in both feedforward and other types of networks, like recurrent neural networks (RNNs).

Backpropagation involves adjusting the weights of the network in the reverse direction (from output to input) based on the error between the predicted output and the actual target during training. While feedforward describes the structure and data flow within the network, backpropagation is a technique used to optimize the model. Feedforward networks are ideal for straightforward tasks where input-output relationships are not sequential or time-dependent. However, for problems involving learning complex patterns over time, such as speech recognition or time-series analysis, networks that leverage backpropagation for training, like RNNs or deep feedforward networks with many hidden layers, become necessary to capture these intricate dependencies.

Typically, in these network arrangements, the weights are iteratively updated via various methods including, but not limited to, stochastic gradient descent algorithms in order to help minimize the loss function until the desired accuracy is achieved. Most modern deep learning frameworks can facilitate this by using reverse-mode automatic differentiation to obtain the partial derivatives of the loss function with respect to each network parameter through recursive application of the chain rule. Colloquially, this is also known as back-propagation. Common gradient descent algorithms can include, but are not limited to, Stochastic Gradient Descent (SGD), Adam, Adagrad etc. The learning rate is an important parameter in gradient descent. Except for SGD, all other methods use adaptive learning parameter tuning. Depending on the objective such as classification or regression, different loss functions such as Binary Cross Entropy (BCE), Negative Log Likelihood Loss (NLLL) or Mean Squared Error (MSE) can be used.

Neural network architecture is commonly used for a wide range of tasks in fields such as computer vision, natural language processing, financial forecasting, and materials science. For instance, it can be employed to recognize patterns in images, such as identifying objects or faces, or to classify text into categories, like spam detection in emails. It is also useful in regression problems, such as predicting stock prices or energy consumption, where input features can be processed to output continuous values. However, this is a general example of an artificial intelligence (AI) model, illustrating how a feedforward neural network works. Depending on the problem, other methods and models may be more appropriate. For example, convolutional neural networks (CNNs) are often used for image processing tasks, while recurrent neural networks (RNNs) are suitable for sequential data like time series data or text. Additionally, simpler models like linear regression, decision trees, or support vector machines (SVMs) may be sufficient if the problem is less complex, or the dataset is relatively small. The embodiment depicted in FIG. 6 is presented as an exemplary ML solution that may be deployed within one or more methods or systems described herein.

In many embodiments, the input layer 610 is the first layer in a neural network 600 and serves as the initial point where raw data is introduced into the model. Each node or neuron in the ML layer corresponds to a distinct feature related to network operations, including FTM exchanges, channel performance, and radio resources. For example, one node might represent the RSSI value of an STA during an FTM exchange, influencing whether the neural network 600 assigns wider channels to improve ranging accuracy despite low signal strength. The number of nodes in the input layer directly depends on the number of features present in the dataset. If there are one-hundred features in the data, the input layer will typically have one-hundred nodes, each conveying one piece of the information to the subsequent layers. In more embodiments, the inputs of the neural network 600 are generally scaled i.e., normalized to have a zero mean and/or unit standard deviation. Scaling can also be applied to the input of hidden layers (using batch or layer normalization) to improve the stability of neural network 600.

Unlike the hidden layers 620 and the output layers 630, the input layer 610 typically does not perform any computations or transformations on the data. Its primary function is often to pass the input data to the next layer in the network, the first hidden layer 621. However, it is often desired that the data fed into this layer is preprocessed appropriately, such as being normalized or standardized, to ensure that the neural network can learn efficiently. Proper preprocessing, like scaling numerical values or encoding categorical variables, can help the network process data uniformly, facilitating more stable and faster convergence during training.

The input layer's design depends on the nature of the problem. For example, in natural language processing, the input layer may represent words encoded as numerical vectors, while in time-series analysis, each node might represent a data point in a sequence. In further examples, if the problem is balancing FTM accuracy with data throughput, the input layer may include features like FTM density, RSSI, channel width, and traffic load for each AP. While the input layer 610 itself does not modify the data, it sets the stage for the neural network to extract complex patterns and relationships through the deeper layers. This flexibility in handling various types of input make the neural network 600 a powerful tool for a diverse set of applications.

With respect to the embodiments described herein, the input layer may be configured with a plurality of inputs providing ranging data 650, AP attributes/parameters, client device attributes/parameters, the first channel requirement information associated with the data exchange operation, the second channel requirement information associated with the ranging operation, or the like. In an example, the ranging data 650 may be associated with a plurality of historical ranging events performed between a set of APs and one or more client devices. The ranging data 650 may include at least one of: a client identifier, a channel number, a channel width, a mode of ranging, a count of frames, or an outcome, associated with each historical ranging event of the plurality of historical ranging events. For example, a model can be configured with a first input 611 that includes the ranging data 650 corresponding to a first historical ranging event of the plurality of historical ranging events, a second input 612 that includes the ranging data 650 corresponding to a second historical ranging event of the plurality of historical ranging events, while additional inputs can be added related to the number of client devices in the network. The nth input 615 may include the ranging data 650 corresponding to an nth historical ranging event of the plurality of ranging events. However, as those skilled in the art will recognize, additional setups can be configured such that the inputs can be configured to also include different parameters of the APs, the number of client devices in the network, the associations of the client devices to the APs, the first and second channel requirement information, among other input types, etc.

In a number of embodiments, the neural network 600 comprises a plurality of hidden layers 620. The embodiment depicted in FIG. 6 comprises a first hidden layer 621, a second hidden layer 622, and an nth hidden layer 625, which are denoted as h₁, h₂, and hₙ respectively. In many embodiments, the hidden layers 620 are where the core of the model's learning and pattern recognition occurs. In each hidden layer, individual neurons receive inputs from the previous layer, apply a set of weights, add a bias, and pass the result through an activation function (e.g., ReLU, leaky ReLU, sigmoid, hyperbolic tangent (tanh), Swish, etc.). This process can introduce non-linearity, allowing the network to capture complex patterns in the data that simple linear models cannot. The intricate web of connections among neurons across layers helps the network transform and process input features into representations that become progressively more abstract and useful for making predictions.

The first hidden layer 621 h₁ receives direct input from the input layer, transforming the raw data into an initial set of features. For example, in the channel width allocation, this layer might begin identifying basic patterns, such as the past allocated channel widths that resulted in the successful ranging operation. The output of the first hidden layer 621 is then passed to a second hidden layer 622 h₂, which builds upon the features identified by the first hidden layer 621. This deeper layer might start recognizing more complex patterns by combining the lower-level features identified earlier. This can continue on until a last, nth hidden layer 625 hₙ continues this abstraction process, allowing the network to recognize even higher-level, more detailed features, such as understanding intricate relationships in the input data.

Each hidden layer adds a level of complexity and abstraction to the network's learning capabilities. The multi-layer structure can enable the network to move from recognizing simple patterns in the first input layer 621 to highly complex, abstract concepts in the deeper layers. The number of hidden layers and neurons within them can vary depending on the problem's complexity. More hidden layers generally allow the network to model more intricate functions, making deep neural networks especially effective for tasks like channel width allocation, channel selection, and complex predictive modeling. However, adding more layers also increases the computational demand and the risk of overfitting, highlighting the need to carefully design and tune these hidden layers for optimal performance.

In various embodiments, the output layer 630 is often the final layer in a neural network and is responsible for producing the network's predictions or classifications based on the information processed through the previous hidden layers 620. Each neuron in the output layer 630 can represent a specific outcome or category that the model can predict. In the embodiment depicted in FIG. 6, the outputs are labeled as “output 1” 631 to “output n,” 635 indicating that the network can be designed to have a varying number of outputs depending on the nature of the problem being solved for. For example, in a binary classification task (e.g., identifying a specific channel width as an optimal channel width vs a non-optimal channel width), there would typically be a single output neuron that provides a probability score for one of the two classes/outcomes. In contrast, for multi-class classification (e.g., categorizing a best suited channel width among a set of available channel widths), the output layer would contain multiple neurons, each corresponding to a different class.

The number of neurons in the output layer 630 can also designed specifically for other types of tasks, such as regression, where the model can predict continuous values. In such cases, the output layer 630 might contain a single neuron representing a numerical prediction, such as the channel width for particular radio of an AP, etc. Alternatively, in complex applications like multi-label classification (where each input can belong to multiple classes simultaneously), the output layer 630 could have multiple neurons, each representing a different class, with each neuron outputting a probability of the input belonging to that specific class.

The activation function used in the output layer can vary based on the desired output. For binary classification, a sigmoid function is commonly used to produce a probability between 0 and 1. For multi-class classifications, a softmax function can be applied to output a set of probabilities that sum to 1, indicating the most likely class. For regression problems, a linear activation function is often used to output a continuous range of values. The flexibility in designing the output layer allows the neural network 600 to be applied to a wide variety of tasks, from simple binary decisions to complex multi-output predictions, making them a versatile tool in artificial intelligence and machine learning.

Although a specific embodiment for an exemplary neural network suitable for carrying out the various steps, processes, methods, and operations described herein is discussed with respect to FIG. 6, any of a variety of systems and/or processes may be utilized in accordance with embodiments of the disclosure. For example, real-world neural networks are often far more complex, featuring many more layers, nodes, and connections than the simplified structure shown in the embodiment depicted in FIG. 6, which is an illustrative example meant to make it easier to explain the basic concepts of neural networks and how they process information. The specific features and functions described herein are not intended to be limiting to this specific embodiment. Additionally, the elements depicted in FIG. 6 may also be interchangeable with other elements of FIGS. 1-5 and 7-13 as required to realize a particularly desired embodiment.

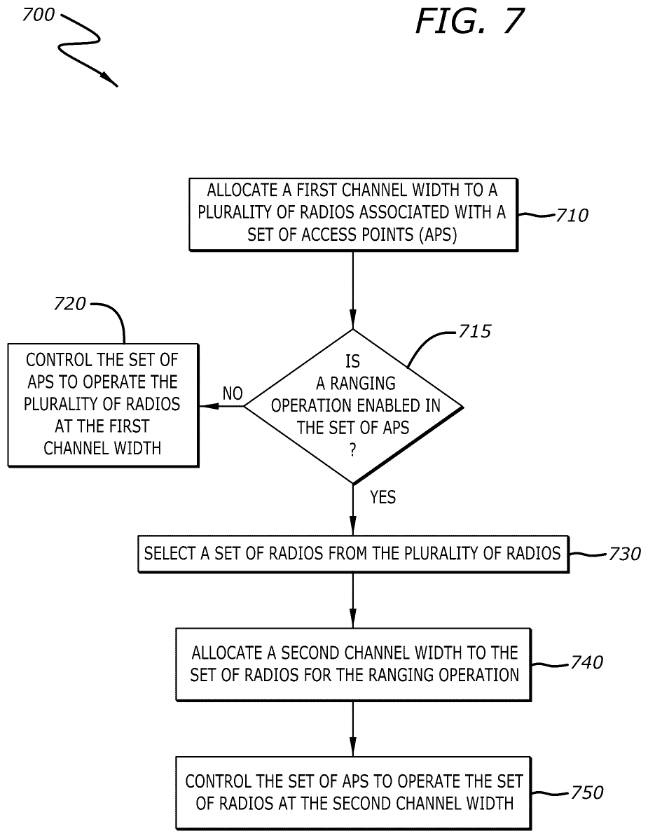

Referring to FIG. 7, a flowchart depicting a process 700 for controlling a set of APs to operate at a first channel width and/or a second channel width in accordance with various embodiments of the disclosure is shown. In many embodiments, the process 700 may allocate the first channel width to a plurality of radios associated with the set of APs (block 710). In an example, a network device may allocate the first channel width to the plurality of radios. The network device may be a part of a network that includes the set of APs and/or one or more client devices. For example, the network device may include a WLC that manages the set of APs to ensure efficient data routing in one or more data exchange operations. In some more examples, the network device may correspond to an AP of the set of APs. In various examples, the first channel width may be allocated to the plurality of radios for the execution of the data exchange operations. The allocated first channel width may represent a frequency range that a channel can occupy for executing the data exchange operations.

In many additional embodiments, in order to allocate the first channel width to the plurality of radios, the process 700 may receive first channel requirement information associated with the data exchange operations. For example, the first channel requirement information may include an indication of specific data throughput to be achieved for the data exchange operations, an indication of interference to be avoidance for the data exchange operations, or the like. In an example, the interference may include an OBSS interference associated with the set of APs. Further, the process 700 may allocate the first channel width to the plurality of radios based on the first channel requirement information. In an example, the process 700 may allocate the first channel width to the plurality of radios in such a way that the OBSS interference is minimized without compromising the specific data throughput.

In a variety of embodiments, the process 700 may determine whether the ranging operation is enabled in the set of APs (block 715). In an example, the network device may determine whether the ranging operation is enabled in the set of APs. As used herein, the ranging operation may include an FTM operation that is associated with various applications, such as a location-tracking application, a navigation application, or the like. In a number of embodiments, the set of APs may be provided with a ranging operation feature associated with the ranging operation. For example, the ranging operation feature may have two states (e.g., an on-state and an off-state). For instance, if the ranging operation feature is in the on-state on the set of APs, the process 700 may determine that the ranging operation is enabled in the set of APs. Conversely, if the ranging operation is in the off-sate on the set of APs, the process 700 may determine that the ranging operation is not enabled in the set of APs.

In numerous embodiments, if the ranging operation is not enabled in the set of APs, the process 700 may control the set of APs to operate the plurality of radios at the first channel width (block 720). In an example, the network device may control the set of APs to operate the plurality of radios at the first channel width. For example, to operate the plurality of radios at the first channel width, the process 700 may select one or more channels corresponding to the first channel width. Further, the process 700 may control the set of APs to operate the plurality of radios on the selected channels for the execution of the data exchange operations with the client devices.

In numerous additional embodiments, if the ranging operation is enabled in the set of APs, the process 700 may select a set of radios from the plurality of radios (block 730). In an example, the network device may select the set of radios from the plurality of radios. In order to select the set of radios, the process 700 may receive second channel requirement information associated with the ranging operation. For example, the second channel requirement information may include an indication of a specific channel width and/or an indication of a specific RSSI range. In various examples, the specific channel width may be greater than the first channel width since the data exchange operations require a narrower channel width that minimizes the OBSS interference and the ranging operation requires a wider channel width that offers improved time and frequency resolutions for the execution of the ranging operation. Further, the process 700 may select the set of radios from the plurality of radios based on the second channel requirement information and an RF band (and/or an RSSI) associated with each radio of the plurality of radios. In an example, the process 700 may select, from the plurality of radios, the set of radios whose RF bands support the specific channel width indicated in the second channel requirement information and/or RSSIs are within the specific RSSI range indicated in the second channel requirement information.

In additional embodiments, the process 700 may allocate a second channel width to the set of radios for the ranging operation (block 740). In an example, the network device may allocate the second channel width to the set of radios. In various examples, the allocated second channel width may be different from the allocated first channel width since the first channel requirement information differs from the second channel requirement information. For example, the allocated second channel width may be equal to or greater than the specific channel width indicated in the second channel requirement information.

In further embodiments, the process 700 may control the set of APs to operate the set of radios at the second channel width (block 750). In an example, the network device may control the set of APs to operate the set of radios at the second channel width. In order to operate the set of radios at the second channel width, the process 700 may select one or more new channels corresponding to the second channel width. Further, the process 700 may control the set of APs to operate the set of radios on the selected channels for the execution of the ranging operation with the client devices.

Although a specific embodiment of the process 700 for carrying out the various steps, processes, methods, and operations described herein is discussed with respect to FIG. 7, any of a variety of systems and/or processes may be utilized in accordance with embodiments of the disclosure. For example, if the ranging operation is enabled in one or more APs of the set of APs, the process 700 may identify, from the plurality of radios, an intermediate set of radios corresponding to the APs in which the ranging operation is enabled, and select the set of radios from the intermediate set of radios for the allocation of the second channel width. The elements depicted in FIG. 7 may also be interchangeable with other elements of FIGS. 1-6 and 8-13 as required to realize a particularly desired embodiment.

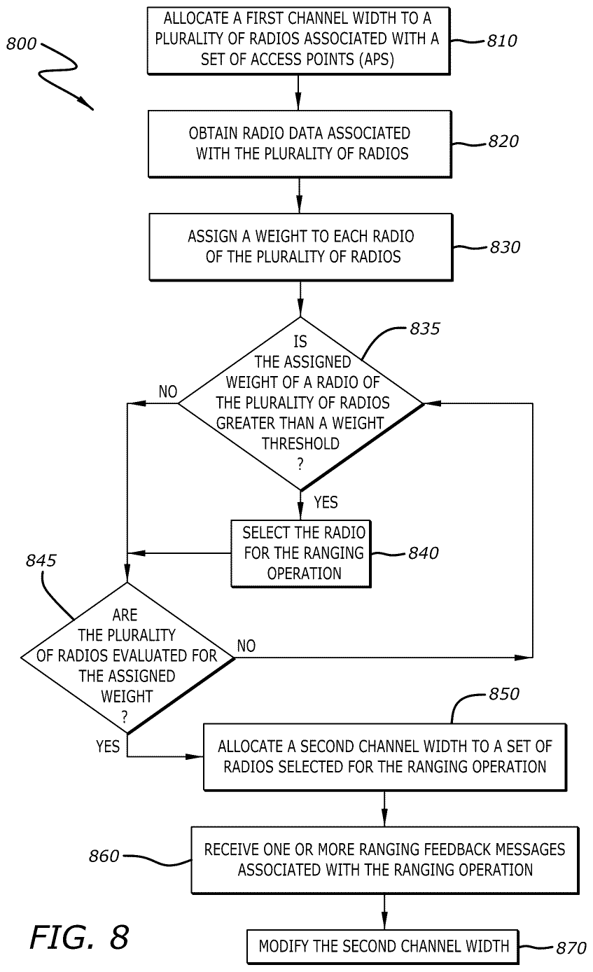

Referring to FIG. 8, a flowchart depicting a process 800 for modifying a channel width in accordance with various embodiments of the disclosure is shown. In many embodiments, the process 800 may allocate a first channel width to a plurality of radios associated with a set of APs (block 810). In various examples, the plurality of radios may include at least one radio associated with each AP of the set of APs. As used herein, the radio may correspond to a communication interface that is configured to transmit (and/or receive) one or more RF signals to facilitate wireless communication with one or more client devices. In an example, a network device may allocate the first channel width to the plurality of radios. As used herein, the network device may correspond to one of an AP of the set of APs or a WLC that manages the set of APs. For example, the process 800 may allocate the first channel width to the plurality of radios for the execution of one or more data exchange operations with the client devices.

In a variety of embodiments, the process 800 may obtain radio data associated with the plurality of radios (block 820). In an example, the network device may obtain the radio data associated with the plurality of radios. The radio data may include at least one of: an RF band, bandwidth usage information of the data exchange operations, or an RSSI, associated with each radio of the plurality of radios. For example, the RF band of a specific radio of the plurality of radios may indicate a specific frequency band (e.g., a 2.4 GHz band, a 5 GHz band, a 6 GHz band, or the like) supported by the specific radio. The bandwidth usage information of the specific radio may indicate a data traffic amount exchanged between the specific radio and a client device of the client devices while performing the data exchange operations. The RRSI associated with the specific radio may indicate a signal power (or signal strength) of a wireless signal of the client device measured by the specific radio.

In more embodiments, the process 800 may assign a weight to each radio of the plurality of radios (block 830). In an example, the network device may assign the weight to each radio of the plurality of radios. In order to assign the weight to each radio of the plurality of radios, the process 800 may acquire at least one of an indication of a specific channel width or an indication of a specific RSSI range. Further, the process 800 may assign the weight to each radio of the plurality of radios based on the RF band associated with each radio of the plurality of radios, the bandwidth usage information associated each radio of the plurality of radios, the RSSI associated with each radio of the plurality of radios, the indication of the specific channel width, and/or the indication of the specific RSSI range. In an example, the process 800 may assign, among the plurality of radios, higher weights to one or more radios whose RF bands support the specific channel width, RSSIs are within the specific RSSI range, and/or data traffic amounts are lower than a data traffic threshold.

In still more embodiments, the process 800 may determine whether the assigned weight of a radio of the plurality of radios is greater than a weight threshold (block 835). In an example, the network device may determine whether the assigned weight of the radio is greater than the weight threshold. For example, the process 800 may determine whether the assigned weight of the radio is greater than the weight threshold by comparing the assigned weight to the weight threshold.

In yet more embodiments, if the assigned weight of the radio is greater than the weight threshold, the process 800 may select the radio for the ranging operation (block 840). In an example, the network device may select the radio for the ranging operation. In still yet more embodiments, if the assigned weight of the radio is not greater than the weight threshold, the process 800 may determine whether all radios in the plurality of radios have been evaluated for the assigned weight (block 845). In an example, the network device may determine whether all radios in the plurality of radios have been evaluated for the assigned weight.

In further embodiments, if all radios in the plurality of radios have not been evaluated for the assigned weight, the process 800 may perform the weight comparison (block 835) and/or the radio selection (block 840) with another radio whose assigned weight has not been evaluated, until the assigned weight is evaluated for all radios in the plurality of radios. In various examples, upon evaluating the assigned weight for all radios in the plurality of radios, the process 800 may obtain a set of radios that are selected for the ranging operation. For instance, the set of radios may include one or more radios of the plurality of radios whose assigned weights are greater than the weight threshold.

In still further embodiments, if all radios in the plurality of radios have been evaluated for the assigned weight, the process 800 may allocate a second channel width to the set of radios for the ranging operation (block 850). In an example, the network device may allocate the second channel width to the set of radios based on the indication of the specific channel width. For example, the process 800 may allocate, as the second channel width, a channel width that is equal to or greater than the specific channel width. In various examples, the allocated second channel width may be different from the allocated first channel width. Specifically, the allocated second channel width may be wider than the allocated first channel width.

In numerous embodiments, the process 800 may receive one or more ranging feedback messages associated with the ranging operation (block 860). In an example, the network device may receive the ranging feedback messages associated with the ranging operation. Each ranging feedback message of the ranging feedback messages may include a result of the execution of the ranging operation. The result of the execution of the ranging operation may include the measurement of distance between a client device of the client devices and an AP of the set of APs, a ranging accuracy of the measurement, or the like. For example, each ranging feedback message of the ranging feedback messages may correspond to an LMR.

In additional embodiments, the process 800 may modify the allocated second channel width (block 870). In an example, the network device may modify the allocated second channel width based on the ranging feedback messages. In order to modify the allocated second channel width, the process 800 may compare the ranging accuracy of each ranging feedback message of the ranging feedback messages with a ranging accuracy threshold to obtain a comparison result. The comparison result may indicate one of: the ranging accuracy is greater than the ranging accuracy threshold, the ranging accuracy is lower than the ranging accuracy threshold, or the ranging accuracy is equal to the ranging accuracy threshold. Further, if the ranging accuracy is lower than the ranging accuracy threshold, the process 800 may either increase or decrease the allocated second channel width by a specific channel width value. For example, the allocated second channel width may be either increased or decreased by the specific channel width value in anticipation that the ranging accuracy matches the ranging accuracy threshold. In an example, if the allocated second channel width corresponds to a 80 MHz channel width, the process 800 may update the allocated second channel width to one of a 40 MHz channel width or 160 MHz channel width in order to match the ranging accuracy with the ranging accuracy threshold.

Although a specific embodiment of the process 800 for carrying out the various steps, processes, methods, and operations described herein is discussed with respect to FIG. 8, any of a variety of systems and/or processes may be utilized in accordance with embodiments of the disclosure. For example, if the ranging accuracy is not lower than the ranging accuracy threshold, the process 800 may prohibit the modification of the allocated second channel width. The elements depicted in FIG. 8 may also be interchangeable with other elements of FIGS. 1-7 and 9-13 as required to realize a particularly desired embodiment.

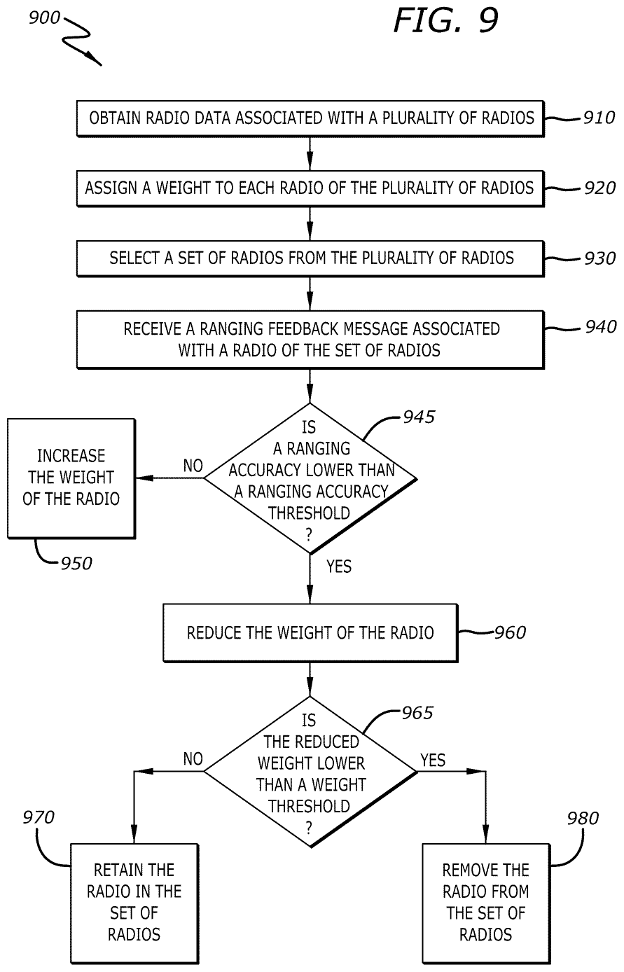

Referring to FIG. 9, a flowchart depicting a process 900 for removing a radio from a set of radios in accordance with various embodiments of the disclosure is shown. In many embodiments, the process 900 may obtain radio data associated with a plurality of radios (block 910). In various examples, the plurality of radios may include at least one radio associated with each AP of the set of APs. As used herein, the radio may correspond to a communication interface that is configured to transmit (and/or receive) one or more RF signals to facilitate wireless communication with one or more client devices. In an example, a network device may obtain the radio data associated with the plurality of radios. As used herein, the network device may correspond to one of an AP of the set of APs or a WLC that manages the set of APs. The radio data may include at least one of: an RF band, bandwidth usage information of a data exchange operation, or an RSSI, associated with each radio of the plurality of radios. For example, the RF band of a specific radio of the plurality of radios may indicate a specific frequency band (e.g., a 2.4 GHz band, a 5 GHz band, a 6 GHz band, or the like) supported by the specific radio. The bandwidth usage information of the specific radio may indicate a data traffic amount exchanged between the specific radio and a client device of the client devices while performing the data exchange operation. The RRSI associated with the specific radio may indicate a signal power (or signal strength) of a wireless signal of the client device measured by the specific radio.

In numerous embodiments, the process 900 may assign a weight to each radio of the plurality of radios (block 920). In an example, the network device may assign the weight to each radio of the plurality of radios. In various examples, the process 900 may assign the weight to each radio of the plurality of radios based on two or more of: the RF band associated with each radio of the plurality of radios, the bandwidth usage information associated each radio of the plurality of radios, the RSSI associated with each radio of the plurality of radios, an indication of a specific channel width, and/or an indication of a specific RSSI range. For example, the process 900 may assign, among the plurality of radios, higher weights to one or more radios whose RF bands support the specific channel width, RSSIs are within the specific RSSI range, and/or data traffic amounts are lower than a data traffic threshold.

In more embodiments, the process 900 may select the set of radios from the plurality of radios (block 930). In an example, the network device may select the set of radios from the plurality of radios. In various examples, the set of radios may be selected from the plurality of radios based on the assigned weight of each radio of the plurality of radios. For example, the process 900 may select, from the plurality of radios, the set of radios whose assigned weights are greater than a weight threshold. Upon selecting the set of radios, the process 900 may utilize the set of radios for executing a ranging operation with the client devices. In an example, the ranging operation may correspond to an FTM operation that is associated with various applications, such as a location-tracking application, a navigation application, or the like.

In still more embodiments, the process 900 may receive a ranging feedback message associated with the radio of the set of radios (block 940). In an example, the network device may receive the ranging feedback message associated with the radio. In various examples, the process 900 may receive, from a client device of the client devices, the ranging feedback message associated with the radio in response to executing the ranging operation with the client device. The ranging feedback message may correspond to an LMR. For example, the ranging feedback message may include the measurement of distance between the client device and an AP of the set of APs having the radio, a ranging accuracy of the measurement, or the like.

In yet more embodiments, the process 900 may determine whether the ranging accuracy is lower than a ranging accuracy threshold (block 945). In an example, the network device may determine whether the ranging accuracy is lower than the ranging accuracy threshold. In various examples, the process 900 may determine whether the ranging accuracy is lower than a ranging accuracy threshold by comparing the ranging accuracy with the ranging accuracy threshold.

In still yet more embodiments, if the ranging accuracy is not lower than the ranging accuracy threshold, the process 900 may increase the assigned weight of the radio (block 950). In an example, the network device may increase the assigned weight of the radio. In various examples, the process 900 may increase the assigned weight of the radio by a first specific value, anticipating that the radio is suitable for executing one or more subsequent ranging operations.

In further embodiments, if the ranging accuracy is lower than the ranging accuracy threshold, the process 900 may reduce the assigned weight of the radio (block 960). In an example, the network device may reduce the assigned weight of the radio. In various examples, the process 900 may reduce the assigned weight by a second specific value. The second specific value may be the same or different from the first specific value.

In still further embodiments, the process 900 may determine whether the reduced weight of the radio is lower than the weight threshold (block 965). In an example, the network device may determine whether the reduced weight of the radio is lower than the weight threshold. In various examples, the process 900 may determine whether the reduced weight of the radio is lower than the weight threshold by comparing the reduced weight to the weight threshold. In still yet further embodiments, if the reduced weight of the radio is not lower than the weight threshold, the process 900 may retain the radio in the set of radios (block 970). In an example, the network device may retain the radio in the set of radios.

In additional embodiments, if the reduced weight of the radio is lower than the weight threshold, the process 900 may remove the radio from the set of radios (block 980). In an example, the network device may remove the radio from the set of radios. In various examples, the process 900 may remove the radio from the set of radios, anticipating that the radio is not suitable for executing the subsequent ranging operations. In some more examples, upon removing the radio from the set of radios, the process 900 may further utilize the updated set of radios to execute the ranging operation with client devices.

Although a specific embodiment of the process 900 for carrying out the various steps, processes, methods, and operations described herein is discussed with respect to FIG. 9, any of a variety of systems and/or processes may be utilized in accordance with embodiments of the disclosure. For example, the process 800 may utilize a remaining set of radios of the plurality of radios for executing the data exchange operation with the client devices. In an example, the remaining set of radios may include one or more radios of the plurality of radios that are excluded from the selected set of radios. The elements depicted in FIG. 9 may also be interchangeable with other elements of FIGS. 1-8 and 10-13 as required to realize a particularly desired embodiment.

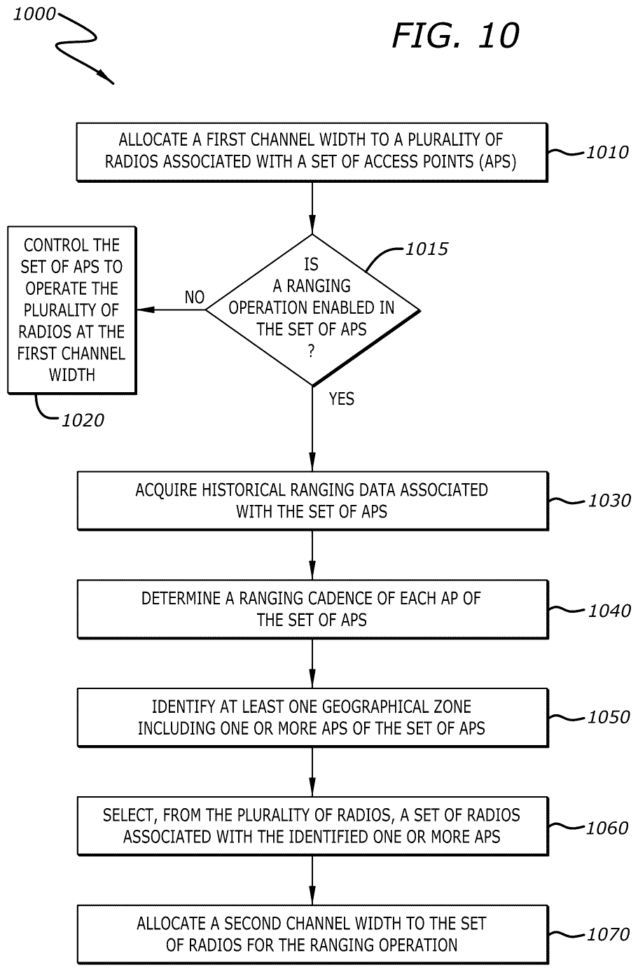

Referring to FIG. 10, a flowchart depicting a process 1000 for allocating at least one of a first channel width or a second channel width to a set of APs in accordance with various embodiments of the disclosure is shown. In many embodiments, the process 1000 may allocate the first channel width to a plurality of radios associated with the set of APs (block 1010). In an example, a network device may allocate the first channel width to the plurality of radios. As used herein, the network device may correspond to one of an AP of the set of APs or a WLC that manages the set of APs. In various examples, to allocate the first channel width, the process 1000 may receive first channel requirement information associated with one or more data exchange operations. For example, the first channel requirement information may include an indication of specific data throughput to be achieved for the data exchange operations, an indication of interference to be avoidance for the data exchange operations, or the like. Upon receiving the first channel requirement information, the process 1000 may select the first channel width for the plurality of radios in such a way that the selected first channel width minimizes the interference specified in the first channel requirement information while maintaining the specific data throughput. Further, the process 1000 may allocate the selected first channel width to the plurality of radios for executing the data exchange operations with one or more client devices.

In many further embodiments, the process 1000 may determine whether the ranging operation is enabled in the set of APs (block 1015). In an example, the network device may determine whether the ranging operation is enabled in the set of APs. As used herein, the ranging operation may correspond to an FTM operation that is associated with various applications, such as a location-tracking application, a navigation application, or the like. In various examples, the set of APs may be provided with a ranging operation feature associated with the ranging operation. For example, the ranging operation feature may have two states (e.g., an on-state and an off-state). For instance, if the ranging operation feature is in the on-state on the set of APs, the process 1000 may determine that the ranging operation is enabled in the set of APs. Conversely, if the ranging operation is in the off-sate on the set of APs, the process 1000 may determine that the ranging operation is not enabled in the set of APs.

In many additional embodiments, if the ranging operation is not enabled in the set of APs, the process 1000 may control the set of APs to operate the plurality of radios at the first channel width (block 1020). In an example, the network device may control the set of APs to operate the plurality of radios at the first channel width. In order to operate the plurality of radios at the first channel width, the process 1000 may select one or more channels corresponding to the first channel width. Further, the process 1000 may control the set of APs to operate the plurality of radios on the selected channels for the execution of the data exchange operations with the client devices.

In further embodiments, if the ranging operation is enabled in the set of APs, the process 1000 may acquire historical ranging data associated with the set of APs (block 1030). In an example, the network device may acquire the historical ranging data associated with the set of APs. In various examples, the historical ranging data may be associated with a plurality of historical ranging events performed between the set of APs and the client devices. The historical ranging data may include ranging data associated with each historical ranging event of the plurality of historical ranging events. For example, the ranging data associated with a historical ranging event of the plurality of historical ranging events may include at least one of: a client identifier, a channel number, a channel width, a mode of ranging, a count of frames, or an outcome of the historical ranging event. The client identifier may indicate a MAC address of a client device of the client devices with which the historical ranging event was performed. The channel number may represent a specific channel (e.g., a channel-38, a channel-46, or the like) that was utilized to perform the historical ranging event. The channel width may represent a specific frequency range (e.g., 40 MHz, 80 MHz, or the like) that was utilized to perform the historical ranging event. The mode of ranging may represent one or more Wi-Fi protocols (e.g., IEEE 802.11mc, IEEE 802.11az, or the like) that were utilized to perform the historical ranging event. The count of frames may represent a number of frames exchanged in the historical ranging event. The outcome of the historical ranging event may indicate either a success of the historical ranging event or a failure of the historical ranging event. Additionally, the historical ranging data may include a ranging feedback message associated with each historical ranging event of the plurality of ranging events. For example, the ranging feedback message may correspond to an LMR.

In still further embodiments, upon acquiring the historical ranging data, the process 1000 may determine an association of each client device of the client devices with at least one AP of the set of APs while the plurality of historical ranging events was performed. In various examples, the association of each client device of the client devices may be determined based on client identifiers included in the historical ranging data. In some more examples, the association of each client device of the client devices may be determined by utilizing one or more Wi-Fi protocols (e.g., IEEE 802.11bi, or the like). In still yet further embodiments, the process 1000 may determine density associated with the client devices based on the client identifiers included in the historical ranging data, a count of ranging feedback messages included in the historical ranging data, and/or the association of each client device of the client devices. As used herein, the density associated with the client devices may represent a count of the client devices that participated in the plurality of historical ranging events.

In more embodiments, the process 1000 may determine a ranging cadence of each AP of the set of APs (block 1040). In an example, the network device may determine the ranging cadence of each AP of the set of APs. In a variety of embodiments, the process 1000 may determine the ranging cadence of each AP of the set of APs based on the outcome of each of the plurality of historical ranging events, the density of the client devices, and/or the count of the ranging feedback messages. For example, the ranging cadence of a specific AP of the set of APs may indicate a count of ranging operations performed by the specific AP.

In still more embodiments, the process 1000 may identify at least one geographical zone including one or more APs of the set of APs (block 1050). In an example, the network device may identify the geographical zone that includes the APs of the set of APs. In various examples, the geographical zone may be identified based on the ranging cadence of each AP of the set of APs. In order to identify the geographical zone, the process 1000 may compare the ranging cadence of each AP of the set of APs with a ranging cadence threshold to determine whether the ranging cadence of each AP of the set of APs is greater than the ranging cadence threshold. Further, the process 1000 may identify the geographical zone in such a way that the geographical zone includes the APs of the set of APs whose ranging cadences are greater than the ranging cadence threshold.

In several embodiments, the process 1000 may select, from the plurality of radios, a set of radios associated with the identified APs (block 1060). In an example, the network device may select the set of radios associated with the identified APs. The selection of the set of radios may enable the process 1000 to filter out radios from the plurality of radios that belong to a different geographical zone, which does not request the ranging operation to be performed.

In additional embodiments, the process 1000 may allocate the second channel width to the set of radios for the ranging operation (block 1070). In an example, the network device may allocate the second channel width to the set of radios for the ranging operation. In various examples, the second channel width may be allocated to the set of radios based on at least one of: channel widths or channel numbers included in the historical ranging data. Further, the process 1000 may control the identified APs to operate the set of radios at the second channel width. For example, the process 1000 may select one or more new channels corresponding to the second channel width and control the identified APs to operate the set of radios on the selected channels for the execution of the ranging operation with the client devices.

Although a specific embodiment of the process 1000 for carrying out the various steps, processes, methods, and operations described herein is discussed with respect to FIG. 10, any of a variety of systems and/or processes may be utilized in accordance with embodiments of the disclosure. For example, if the identified APs receive one or more ranging feedback messages in response to executing the ranging operation, the process 1000 may update the set of radios based on the ranging feedback messages. The elements depicted in FIG. 10 may also be interchangeable with other elements of FIGS. 1-9 and 11-13 as required to realize a particularly desired embodiment.

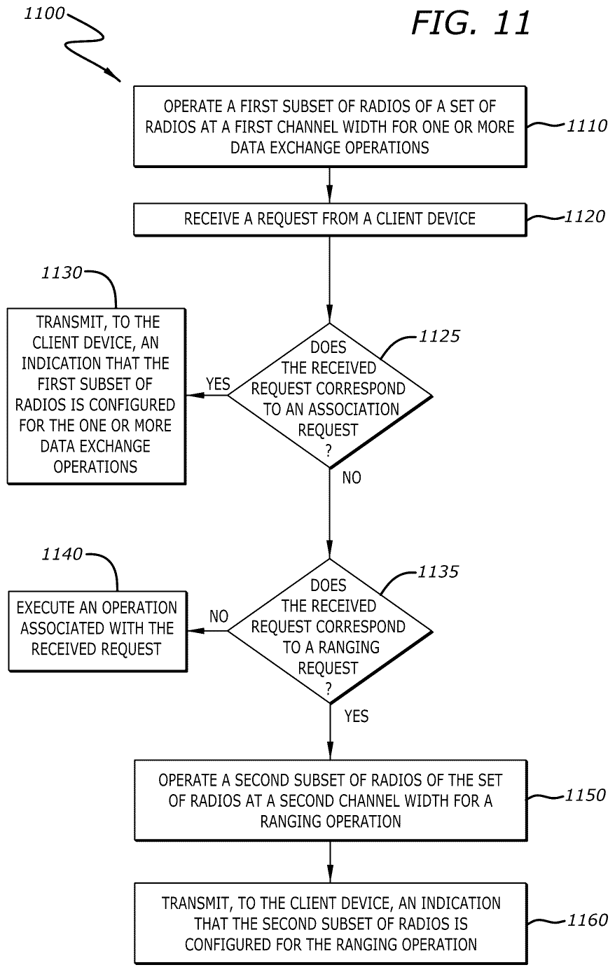

Referring to FIG. 11, a flowchart depicting a process 1100 for transmitting at least one of a data exchange indication or a ranging indication in accordance with various embodiments of the disclosure is shown. In many embodiments, the process 1100 may operate a first subset of radios of a set of radios at a first channel width for one or more data exchange operations (block 1110). In an example, a network device may operate the first subset of radios of the set of radios at the first channel width for the data exchange operations. As used herein, the network device may correspond to an AP that allows at least one client device to connect to the Internet or another client device. In various examples, the network device may include the set of radios. For example, each radio of the set of radios may include a communication interface that is configured to transmit (and/or receive) one or more RF signals with the client device to facilitate the wireless connection with the client device. As used herein, the first channel width may represent a frequency range that a channel can occupy for executing the data exchange operations.

In many additional embodiments, in order to operate the first subset of radios at the first channel width, the process 1100 may receive first control information associated with the data exchange operations. For example, the first control information may include an indication that the first channel width is allocated to the first subset of radios. The first control information may be received from another network device that is a neighbor of the network device or a WLC that controls the network device. Upon receiving the first control information, the process 1100 may identify a first set of channels corresponding to the first channel width. Further, the process 1100 may operate the first subset of radios on the identified first set of channels.

In many further embodiments, in order to operate the first subset of radios at the first channel width, the process 1100 may acquire first channel requirement information associated with the data exchange operations. For example, the first channel requirement information may include an indication of specific data throughput and/or an indication of interference. In an example, the process 1100 may select, as the first channel width, a channel width that minimizes the interference indicated in the first channel requirement information without compromising the specific data throughput. Upon selecting the first channel width, the process 1100 may select, from the set of radios, the first set of radios that support the first channel width. Upon selecting the first set of radios, the process 1100 may operate the first subset of radios at the first channel width by selecting the first set of channels corresponding to the first channel width and operating the first subset of radios on the selected first set of channels.

In further embodiments, the process 1100 may receive a request from the client device (block 1120). In an example, the network device may receive the request from the client device. In various examples, the request may include at least one of an association request, a ranging request, or the like. For example, the association request may include an indication indicating that the client device wants to join the network associated with the network device. The ranging request may include an indication indicating that the client device wants to execute a ranging operation with the network device, an identifier (e.g., a MAC address) of the client device, or the like. For instance, the ranging request may correspond to an FTM request.

In still further embodiments, the process 1100 may determine whether the received request corresponds to the association request (block 1125). In an example, the network device may determine whether the received request corresponds to the association request. For example, if the received request includes the indication indicating that the client device wants to join the network, the process 1100 may determine that the received request corresponds to the association request. Conversely, if the received request includes a different indication, the process 1100 may determine that the received request does not correspond to the association request.

In more embodiments, if the received request corresponds to the association request, the process 1100 may transmit, to the client device, an indication that the first set of radios is configured for the data exchange operations (block 1130). In an example, the network device may transmit, to the client device, the indication that the first set of radios is configured for the data exchange operations. Hereinafter, the indication indicating that the first set of radios is configured for the data exchange operations may be referred to as the data exchange indication. The data exchange indication may include a BSSID of the network device, an identifier of each radio of the first subset of radios, and/or channel information associated with the first subset of radios. In various examples, upon transmitting the data exchange indication to the client device, the process 1100 may receive a data exchange request from the client device. For example, the data exchange request may include one of the first channel requirement information or new first channel requirement information. In an example, if the data exchange request includes the first channel requirement information, the process 1100 may execute the data exchange operations with the client device by utilizing the first channel width. Conversely, if the data exchange request includes the new first channel requirement information, the process 1100 may adjust the first channel width to meet the new first channel requirement information, and execute the data exchange operations with the client device by utilizing the adjusted first channel width.

In still more embodiments, if the received request does not correspond to the association request, the process 1100 may determine whether the received request corresponds to the ranging request (block 1135). In an example, the network device may determine whether the received request corresponds to the ranging request. For example, if the received request includes the indication indicating that the client device wants to execute the ranging operation with the network device, the process 1100 may determine that the received request corresponds to the ranging request. Conversely, if the received request includes a different indication, the process 1100 may determine that the received request does not correspond to the ranging request.

In yet more embodiments, if the received request does not correspond to the ranging request, the process 1100 may execute an operation associated with the received request (block 1140). In an example, the network device may execute the operation associated with the received request. In various examples, the operation may be different from the data exchange operation and/or the ranging operation. For example, the operation may include a roaming handover operation, a power management operation, or the like.

In additional embodiments, if the received request corresponds to the ranging request, the process 1100 may operate a second subset of radios of the set of radios at a second channel width for the ranging operation (block 1150). In an example, the network device may operate the second subset of radios at the second channel width for the ranging operation. As used herein, the second channel width may represent a frequency range that a channel can occupy for executing the ranging operation.

In still additional embodiments, in order to operate the second subset of radios at the second channel width, the process 1100 may report the reception of the ranging request to the WLC (or another network device) in anticipation that the WLC transmits second control information associated with the ranging operation. For example, the second control information may include an indication that the second channel width is allocated to the second subset of radios. Upon receiving the second control information, the process 1100 may identify a second set of channels corresponding to the second channel width. Further, the process 1100 may operate the second subset of radios on the identified second set of channels.

In still yet additional embodiments, in order to operate the second subset of radios at the second channel width, the process 1100 may acquire second channel requirement information associated with the ranging operation. For example, the second channel requirement information may include an indication of specific channel width. In an example, the process 1100 may select, as the second channel width, a channel width that is greater than or equal to the specific channel width. Upon selecting the second channel width, the process 1100 may select, from the set of radios, the second set of radios that support the second channel width. Upon selecting the second set of radios, the process 1100 may operate the second subset of radios at the second channel width by selecting the second set of channels corresponding to the second channel width and operating the second subset of radios on the selected second set of channels.

In several embodiments, the process 1100 may transmit, to the client device, an indication that the second subset of radios is configured for the ranging operation (block 1160). In an example, the network device may transmit, to the client device, the indication that the second subset of radios is configured for the ranging operation. Hereinafter, the indication indicating that the second set of radios is configured for the ranging operation may be referred to as the ranging indication. The ranging indication may include the BSSID of the network device, an identifier of each radio of the second subset of radios, and/or channel information associated with the second subset of radios. Upon transmitting the ranging indication, the process 1100 may execute the ranging operation with the client device to assist the client device in determining its distance relative to the network device.

Although a specific embodiment of the process 1100 for carrying out the various steps, processes, methods, and operations described herein is discussed with respect to FIG. 11, any of a variety of systems and/or processes may be utilized in accordance with embodiments of the disclosure. For example, the process 1100 may prohibit transmission of an announcement indicating availability of the second set of radios for the data exchange operations in response to operating the second subset of radios at the second channel width. The elements depicted in FIG. 11 may also be interchangeable with other elements of FIGS. 1-10 and 12-13 as required to realize a particularly desired embodiment.

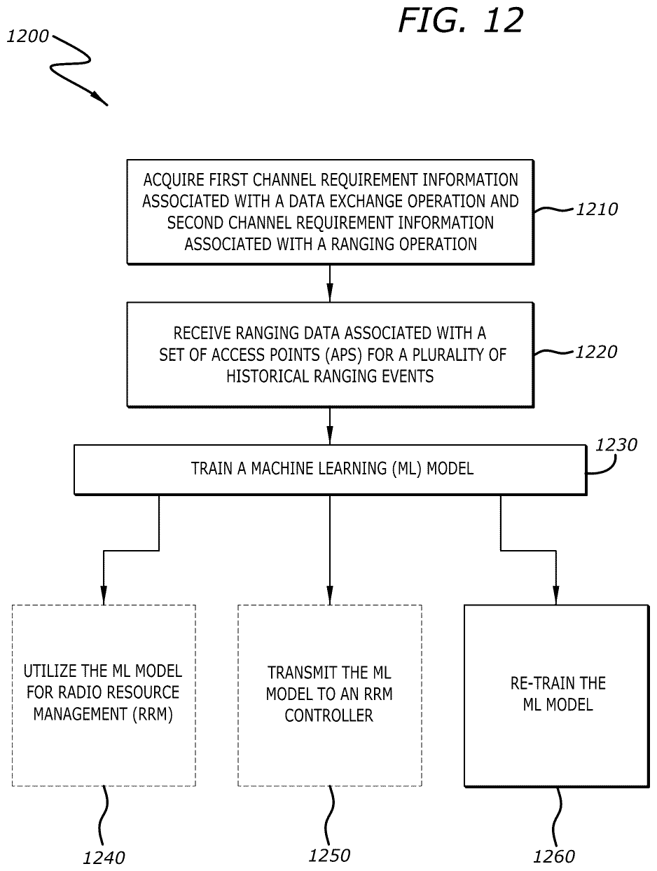

Referring to FIG. 12, a flowchart depicting a process 1200 for training an ML model in accordance with various embodiments of the disclosure is shown. In many embodiments, the process 1200 may acquire first channel requirement information associated with a data exchange operation and second channel requirement information associated with a ranging operation (block 1210). In an example, a computing device may acquire the first channel requirement information associated with the data exchange operation and the second channel requirement information associated with the ranging operation. As used herein, the computing device may correspond to a WLC, an AP, a computer, or the like. In various examples, the first channel requirement information may include an indication of specific data throughput to be achieved for the data exchange operation, an indication of interference to be avoided for the data exchange operation, or the like. The second channel requirement information may include an indication of a specific channel width, an indication of at least one specific RSSI value, or the like.

In further embodiments, the process 1200 may receive ranging data associated with a set of APs for a plurality of historical ranging events (block 1220). In an example, the computing device may receive the ranging data associated with the set of APs for the plurality of historical ranging events. In various examples, the ranging data may be received from the set of APs. In some more examples, the ranging data may be uploaded by a developer or the like.

In still further embodiments, the ranging data of an AP of the set of APs for a historical ranging event of the plurality of historical ranging events may include at least one of: a client identifier, a channel number, a channel width, a mode of ranging, a count of frames, or an outcome of the historical ranging event. The client identifier may indicate a MAC address of a client device with which the historical ranging event was performed. The channel number may represent a specific channel (e.g., a channel-38, a channel-46, or the like) that was utilized to perform the historical ranging event. The channel width may represent a specific frequency range (e.g., 40 MHz, 80 MHz, or the like) that was utilized to perform the historical ranging event. The mode of ranging may represent one or more Wi-Fi protocols (e.g., IEEE 802.11mc, IEEE 802.11az, or the like) that were utilized to perform the historical ranging event. The count of frames may represent a number of frames exchanged in the historical ranging event. The outcome of the historical ranging event may indicate either a success of the historical ranging event or a failure of the historical ranging event.

In still yet further embodiments, the ranging data for the plurality of historical ranging events may include a count of client devices that participated in the plurality of historical ranging events. In further additional embodiments, the ranging data for the plurality of historical ranging events may include a ranging feedback message for each historical ranging event of the plurality of historical ranging events. For example, the ranging feedback message may include the measurement of distance of a client device of the client devices relative to a specific AP of the set of APs, a ranging accuracy of the measurement, or the like.

In additional embodiments, the process 1200 may train the ML model (block 1230). In an example, the computing device may train the ML model. For example, the ML model may include a reinforcement learning model, a NN, a DNN, a generative model, or the like. In various examples, the ML model may be trained based on the received ranging data. In numerous examples, the ML model may be trained in a such way that the trained ML model is configured to reserve one or more radios of the set of APs to utilize a target channel width for the ranging operation while allocating a channel width for the data exchange operation. In a variety of examples, the channel width may be allocated such that the interference indicated in the first channel requirement information is minimized without compromising on the specific data throughput. In more examples, the target channel width may be different from the channel width allocated for the data exchange operation. Specifically, the target channel width may be wider than the channel width allocated for the data exchange operation. For example, the target channel width may be equal to or greater than the specific channel width indicated in the second channel requirement information.

In several embodiments, the process 1200 may utilize the ML model for RRM (block 1240). In an example, the WLC or the AP may utilize the ML model for the RRM. In various examples, the ML model may be utilized to allocate the channel width to a first set of radios of the set of APs for the data exchange operation and allocate the target channel width to a second set of radios of the set of APs for the ranging operation.

In several more embodiments, the process 1200 may transmit the ML model to an RRM controller (block 1250). In an example, the computing device may transmit the ML model to the RRM controller. In various examples, the RRM controller may be embodied in the AP of the set of APs or the WLC. The RRM controller may utilize the ML model to allocate the channel width to the first set of radios for the data exchange operation and allocate the target channel width to the second set of radios for the ranging operation.

In a number of embodiments, the process 1200 may re-train the ML model (block 1260). In an example, the computing device may re-train the ML model. In various examples, in response to executing the data exchange operation and/or the ranging operation, the process 1200 may acquire at least one data exchange feedback message and/or at least one ranging feedback message, respectively. For example, the data exchange feedback message may include an accuracy of the data exchange operation indicating whether the data exchange operation was executed with the required data throughput or the like. The ranging feedback message may include the measurement of the distance, the ranging accuracy of the measurement, or the like. Upon acquiring the exchange feedback message and/or the ranging feedback message, the process 1200 may re-train the ML model to update the second set of radios and/or modify at least one of the channel width or the target channel width. In an example, the ML model may be re-trained to remove at least one radio from the second set of radios if the radio has executed the ranging operation with a ranging accuracy lower than a ranging accuracy threshold for one or more attempts. In additional examples, the ML model may be re-trained to either increase or decrease the target channel width in order to align the ranging accuracy with the ranging accuracy threshold.

Although a specific embodiment of the process 1200 for carrying out the various steps, processes, methods, and operations described herein is discussed with respect to FIG. 12, any of a variety of systems and/or processes may be utilized in accordance with embodiments of the disclosure. For example, the process 1200 may acquire new second channel requirement information indicating a new specific channel width for the ranging operation, and re-train the ML model based on the new second channel requirement information. The elements depicted in FIG. 12 may also be interchangeable with other elements of FIGS. 1-11 and 13 as required to realize a particularly desired embodiment.

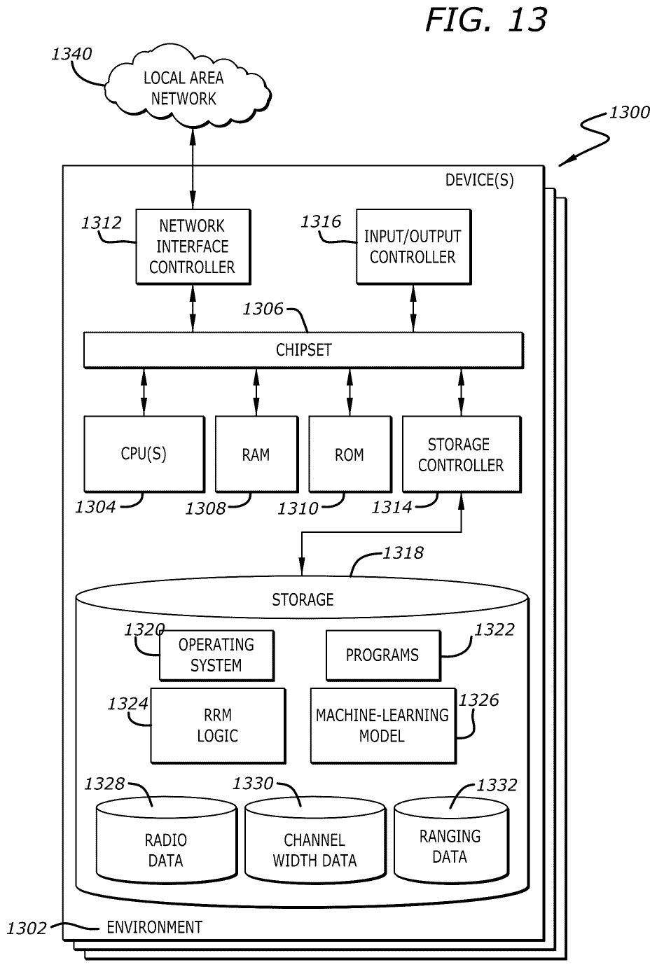

Referring to FIG. 13, a conceptual block diagram of a device 1300 suitable for configuration with an RRM logic in accordance with various embodiments of the disclosure is shown. The embodiment of the conceptual block diagram depicted in FIG. 13 can illustrate a conventional server, computer, workstation, desktop computer, laptop, tablet, network appliance, e-reader, smartphone, or other computing device, and can be utilized to execute any of the application or logic components presented herein. The embodiment of the conceptual block diagram depicted in FIG. 13 can also illustrate an access point, a switch, or a router in accordance with various embodiments of the disclosure. The device 1300 may, in many non-limiting examples, correspond to physical devices or to virtual resources described herein.

In many embodiments, the device 1300 (e.g., a WLC or an AP) may include an environment 1302 such as a baseboard or “motherboard,” in physical embodiments that can be configured as a printed circuit board with a multitude of components or devices connected by way of a system bus or other electrical communication paths. Conceptually, in virtualized embodiments, the environment 1302 may be a virtual environment that encompasses and executes the remaining components and resources of the device 1300. In more embodiments, one or more processors 1304, such as, but not limited to, central processing units (“CPUs”) can be configured to operate in conjunction with a chipset 1306. The processor(s) 1304 can be standard programmable CPUs that perform arithmetic and logical operations necessary for the operation of the device 1300.

In a number of embodiments, the processor(s) 1304 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 1306 may provide an interface between the processor(s) 1304 and the remainder of the components and devices within the environment 1302. The chipset 1306 can provide an interface to a random-access memory (“RAM”) 1308, which can be used as the main memory in the device 1300 in some embodiments. The chipset 1306 can further be configured to provide an interface to a computer-readable storage medium such as a read-only memory (“ROM”) 1310 or non-volatile RAM (“NVRAM”) for storing basic routines that can help with various tasks such as, but not limited to, starting up the device 1300 or transferring information between the various components and devices. The ROM 1310 or NVRAM can also store other application components necessary for the operation of the device 1300 in accordance with various embodiments described herein.

Additional embodiments of the device 1300 can be configured to operate in a networked environment using logical connections to remote computing devices and computer systems through a network, such as the network 1340. The chipset 1306 can include functionality for providing network connectivity through a network interface card (“NIC”) 1312, which may comprise a gigabit Ethernet adapter or similar component. The NIC 1312 can be capable of connecting the device 1300 to other devices over the network 1340. It is contemplated that multiple NICs 1312 may be present in the device 1300, connecting the device to other types of networks and remote systems.

In further embodiments, the device 1300 can be connected to a storage 1318 that provides non-volatile storage for data accessible by the device 1300. The storage 1318 can, for instance, store an operating system 1320, applications 1322, radio data 1328, channel width data 1330, and ranging data 1332 which are described in greater detail below. The storage 1318 can be connected to the environment 1302 through a storage controller 1314 connected to the chipset 1306. In certain embodiments, the storage 1318 can consist of one or more physical storage units. The storage controller 1314 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 1300 can store data within the storage 1318 by transforming the physical state of the physical storage units to reflect the information being stored. The specific transformation of physical state can depend on various factors. Examples of such factors can include, but are not limited to, the technology used to implement the physical storage units, whether the storage 1318 is characterized as primary or secondary storage, and the like.

In still more embodiments, the device 1300 can store information within the storage 1318 by issuing instructions through the storage controller 1314 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1300 can further read or access information from the storage 1318 by detecting the physical states or characteristics of one or more particular locations within the physical storage units.

In addition to the storage 1318 described above, the device 1300 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1300. In some examples, the operations performed by a cloud computing network, and or any components included therein, may be supported by one or more devices similar to device 1300. Stated otherwise, some or all of the operations performed by the cloud computing network, and or any components included therein, may be performed by one or more devices 1300 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CDROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1318 can store an operating system 1320 utilized to control the operation of the device 1300. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 1318 can store other system or application programs and data utilized by the device 1300.

In many additional embodiments, the storage 1318 or other computer-readable storage media is encoded with computer-executable instructions which, when loaded into the device 1300, may transform it from a general-purpose computing system into a special-purpose computer capable of implementing the embodiments described herein. These computer-executable instructions may be stored as application 1322 and transform the device 1300 by specifying how the processor(s) 1304 can transition between states, as described above. In some embodiments, the device 1300 has access to computer-readable storage media storing computer-executable instructions which, when executed by the device 1300, perform the various processes described above with regard to FIGS. 1-13. In certain embodiments, the device 1300 can also include computer-readable storage media having instructions stored thereupon for performing any of the other computer-implemented operations described herein.

In many further embodiments, the device 1300 may include an RRM logic 1324. The RRM logic 1324 can be configured to perform one or more of the various steps, processes, operations, or other methods that are described above. Often, the RRM logic 1324 can be a set of instructions stored within a non-volatile memory that, when executed by the processor(s)/controller(s) 1304 can carry out these steps, etc. In some embodiments, the RRM logic 1324 may be a client application that resides on a network-connected device, such as, but not limited to, a server, switch, personal or mobile computing device in a single or distributed arrangement.

Various embodiments are based on the recognition that the advent of Multi-Link Operation (MLO) may allow a client device to connect to one or more APs by utilizing multiple links of the client device. This advanced functionality may enable the client device to run multiple operations (e.g., the data exchange operation, the ranging operation, or the like) in parallel, each requiring different radio requirements. Current RRM techniques may assist in selecting channels for the data exchange operation by incorporating channel requirements, such as throughput, signal strength, and interference management. However, these RRM techniques may not incorporate channel requirements of the ranging operation. As a result, the current RRM techniques may select only narrower channels that would avoid interference. However, the ranging operation may be optimal if the ranging operation is executed with wider channels. To this end, in a number of embodiments, the RRM logic 1324 may be provided to balance the channel requirements of both the data exchange operation and the ranging operation.

In numerous embodiments, when the device 1300 is configured as the WLC, the RRM logic 1324 may be configured to allocate a first channel width to a plurality of radios of a set of APs for the data exchange operation. Further, the RRM logic 1324 may be configured to determine whether the set of APs is enabled for the ranging operation and allocate a second channel width to a set of radios of the plurality of radios to the ranging operation in response to determining that the set of APs is enabled for the ranging operation. In various examples, the second channel width may be different from the first channel width. Specifically, the second channel width may be wider than the first channel width. In numerous more embodiments, when the device 1300 is configured as the AP, the RRM logic 1324 may be configured to operate a first subset of radios of a set of radios of the AP at the first channel width for the data exchange operation. Further, the RRM logic 1324 may configured to receive a ranging request for the ranging operation and operate a second set of radios of the set of radios at the second channel width for the ranging operation in response to receiving the ranging request. The allocation of the first channel width for the data exchange operation and the second channel width for the ranging operation may enable the RRM logic 1324 to suppress inefficiencies in channel selection that could lead to suboptimal performance in one or both the data exchange and ranging operations.

In numerous additional embodiments, the radio data 1328 may include at least one of: an RF band, bandwidth usage information of the data exchange operation, or an RSSI, associated with each radio of the plurality of radios. For example, the RF band of a specific radio of the plurality of radios may indicate a specific frequency band (e.g., a 2.4 GHz band, a 5 GHz band, a 6 GHz band, or the like) supported by the specific radio. The bandwidth usage information of the specific radio may indicate a data traffic amount exchanged between the specific radio and a client device of the client devices while performing the data exchange operation. The RRSI associated with the specific radio may indicate a signal power (or signal strength) of a wireless signal of the client device measured by the specific radio.

In a variety of embodiments, the channel width data 1330 may include at least one of first channel requirement information associated with the data exchange operation or second channel requirement information associated with the ranging operation. For example, the first channel requirement information may include an indication of specific data throughput to be achieved for the data exchange operation, an indication of interference to be avoidance for the data exchange operation, or the like. The second channel requirement information may include at least one of: an indication of a specific channel width beyond which the ranging operation is optimal or an indication of a specific RSSI range within which the ranging operation is optimal. Additionally, the channel width data 1330 may include the allocated first channel width for the data exchange operation and the allocated second channel width for the ranging operation.

In various further embodiments, the ranging data 1332 may include historical ranging data associated with a plurality of historical ranging events performed between the set of APs and one or more client devices. For example, the historical ranging data of a historical ranging event of the plurality of historical ranging events may include at least one of: a client identifier, a channel number, a channel width, a mode of ranging, a count of frames, or an outcome of the historical ranging event. The client identifier may indicate a MAC address of a client device of the client devices with which the historical ranging event was performed. The channel number may represent a specific channel (e.g., a channel-38, a channel-46, or the like) that was utilized to perform the historical ranging event. The channel width may represent a specific frequency range (e.g., 40 MHz, 80 MHz, or the like) that was utilized to perform the historical ranging event. The mode of ranging may represent one or more Wi-Fi protocols (e.g., IEEE 802.11mc, IEEE 802.11az, or the like) that were utilized to perform the historical ranging event. The count of frames may represent a number of frames exchanged in the historical ranging event. The outcome of the historical ranging event may indicate either a success of the historical ranging event or a failure of the historical ranging event. Additionally, the ranging data 1332 may include a ranging feedback message associated with each historical ranging event of the plurality of ranging events. For example, the ranging feedback message may correspond to an LMR.

In still further embodiments, the device 1300 can also include one or more input/output controllers 1316 for receiving and processing input from a number of input devices, such as a keyboard, a mouse, a touchpad, a touch screen, an electronic stylus, or other type of input device. Similarly, an input/output controller 1316 can be configured to provide output to a display, such as a computer monitor, a flat panel display, a digital projector, a printer, or other type of output device. Those skilled in the art will recognize that the device 1300 might not include all of the components shown in FIG. 13 and can include other components that are not explicitly shown in FIG. 13 or might utilize an architecture completely different than that shown in FIG. 13.

Finally, in numerous additional embodiments, data may be processed into a format usable by a machine-learning model 1326 (e.g., feature vectors), and or other pre-processing techniques. The machine-learning (“ML”) model 1326 may be any type of ML model, such as supervised models, reinforcement models, or unsupervised models. The ML model 1326 may include one or more of linear regression models, logistic regression models, decision trees, Naïve Bayes models, neural networks, k-means cluster models, random forest models, or other types of ML models 1326.

The ML model(s) 1326 can be configured to generate inferences to make predictions or draw conclusions from data. An inference can be considered the output of a process of applying a model to new data. This can occur by learning from at least the radio data 1328, the channel width data 1330, and the ranging data 1332 and using that learning to predict future outcomes. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 1326 may be generated by human/administrator verifications or may compare predicted outcomes with actual outcomes. Further, when the device 1300 is configured as the WLC, the ML model(s) 1326 may be utilized to allocate the second channel width to the set of radios of the set of APs for the ranging operation by learning the radio data 1328, the channel width data 1330, and/or the ranging data 1332. Furthermore, when the device 1300 is configured as the AP, the ML model(s) 1326 may be utilized to allocate the second channel width to a subset of radios of the AP for the ranging operation by learning the radio data 1328, the channel width data 1330, and/or the ranging data 1332.

Although a specific embodiment for a device 1300 suitable for configuration with the RRM logic for carrying out the various steps, processes, methods, and operations described herein is discussed with respect to FIG. 13, any of a variety of systems and/or processes may be utilized in accordance with embodiments of the disclosure. For example, the device 1300 may correspond to a mobile computing device such as a laptop (or a smartphone), or may correspond to a network device such as an AP. The elements depicted in FIG. 13 may also be interchangeable with other elements of FIGS. 1-12 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A network device, comprising:
a network controller configured to provide access to a network including a set of Access Points (APs), wherein the set of APs is associated with a plurality of radios;
a processor; and
a memory communicatively coupled to the processor, wherein the memory comprises a Radio Resource Management (RRM) logic configured to:
allocate a first channel width to the plurality of radios for one or more data exchange operations;
determine that the set of APs is enabled for a ranging operation; and
allocate a second channel width to a set of radios of the plurality of radios for the ranging operation, wherein the second channel width is different from the first channel width.

2. The network device of claim 1, wherein to allocate the second channel width to the set of radios, the RRM logic is further configured to:
obtain radio data associated with the plurality of radios;
assign a weight to each radio of the plurality of radios based on the radio data;
compare the assigned weight of each radio of the plurality of radios with a weight threshold; and
select, from the plurality of radios, the set of radios based on the comparison, wherein the second channel width is allocated to the selected set of radios.

3. The network device of claim 2, wherein the radio data comprises at least one of: a Radio Frequency (RF) band, bandwidth usage information of the one or more data exchange operations, or a Received Signal Strength Indicator (RSSI), associated with at least one radio of the plurality of radios.

4. The network device of claim 2, wherein the RRM logic is further configured to:
receive one or more ranging feedback messages associated with the ranging operation; and
modify the second channel width based on the one or more ranging feedback messages.

5. The network device of claim 4, wherein modifying the second channel width comprises one of increasing the second channel width or decreasing the second channel width.

6. The network device of claim 2, wherein the RRM logic is further configured to:
receive a ranging feedback message associated with a radio of the set of radios, wherein the ranging feedback message indicates a ranging accuracy associated with the ranging operation;
compare the ranging accuracy with a ranging accuracy threshold; and
reduce the weight of the radio in response to the ranging accuracy being lower than the ranging accuracy threshold.

7. The network device of claim 6, wherein the RRM logic is further configured to:
determine that the reduced weight of the radio is lower than the weight threshold; and
remove the radio from the set of radios in response to determining that the reduced weight of the radio is lower than the weight threshold.

8. The network device of claim 6, wherein the ranging feedback message comprises a Location Measurement Report (LMR).

9. The network device of claim 1, wherein to allocate the second channel width to the set of radios, the RRM logic is further configured to:
acquire historical ranging data associated with the set of APs;
determine a ranging cadence of each AP of the set of APs based on the historical ranging data; and
select the set of radios from the plurality of radios based on the determined ranging cadence.

10. The network device of claim 9, wherein to select the set of radios from the plurality of radios, the RRM logic is further configured to:
compare the determined ranging cadence with a ranging cadence threshold; and
identify at least one geographical zone including one or more APs of the set of APs with the determined ranging cadence being greater than the ranging cadence threshold, wherein the selected set of radios is associated with the one or more APs.

11. The network device of claim 1, wherein the RRM logic is further configured to control one or more radios, of the plurality of radios that are excluded from the set of radios, to prohibit transmission of a ranging capability announcement.

12. The network device of claim 1, wherein the RRM logic is further configured to utilize a Machine Learning (ML) model to allocate the second channel width to the set of radios.

13. A network device, comprising:
a set of radios;
a processor; and
a memory communicatively coupled to the processor, wherein the memory comprises a Radio Resource Management (RRM) logic configured to:
operate a first subset of radios of the set of radios at a first channel width for one or more data exchange operations;
receive a ranging request for a ranging operation; and
operate a second subset of radios of the set of radios at a second channel width for the ranging operation, wherein the second channel width is different from the first channel width.

14. The network device of claim 13, wherein the RRM logic is further configured to:
receive an association request from a client device; and
transmit, to the client device, an indication that the first subset of radios is configured for the one or more data exchange operations in response to receiving the association request.

15. The network device of claim 14, wherein the indication comprises at least one of a Basic Service Set Identifier (BSSID) of the network device or channel information associated with the first subset of radios.

16. The network device of claim 13, wherein the ranging request is received from a client device, and the RRM logic is further configured to transmit, to the client device, an indication that the second subset of radios is configured for the ranging operation.

17. The network device of claim 16, wherein the indication comprises at least one of a Basic Service Set Identifier (BSSID) of the network device or channel information associated with the second subset of radios.

18. The network device of claim 13, wherein the RRM logic is further configured to prohibit transmission of an announcement indicating availability of the second subset of radios for the one or more data exchange operations in response to operating the second subset of radios at the second channel width.

19. A method, comprising:
acquiring first channel requirement information associated with a data exchange operation and second channel requirement information associated with a ranging operation;
receiving ranging data associated with a set of Access Points (APs) for a plurality of historical ranging events; and
training a Machine Learning (ML) model based on the first channel requirement information, the second channel requirement information, and the ranging data, wherein the trained ML model is configured to reserve one or more radios of the set of APs to utilize a target channel width for the ranging operation, and the target channel width is different from a channel width associated with the data exchange operation.

20. The method of claim 19, wherein the ranging data for a historical ranging event of the plurality of historical ranging events comprises at least one of: a client device identifier, a channel number, a channel width, a mode of ranging, a count of frames exchanged in the historical ranging event, or an outcome of the historical ranging event.
